(19) United States
(12) Patent Application Publication
(10) Pub. No.: US 2024/0150133 A1
(43) Pub. Date: May 9, 2024

(54) SINGULATING CONVEYOR WITH DIFFERENT SPEED ZONES IN A HERRINGBONE PATTERN AND METHOD OF OPERATION THEREOF

(71) Applicant: ROACH MANUFACTURING CORPORATION, Trumann, AR (US)

(72) Inventors: Michael R. PARKS, Trumann, AR (US); Eddie Joe MOODY, Trumann, AR (US); Christopher E. Kain, Tyronza, AR (US)

(73) Assignee: ROACH MANUFACTURING CORPORATION, Trumann, AR (US)

(21) Appl. No.: 18/458,501

(22) Filed: Aug. 30, 2023

Related U.S. Application Data
(63) Continuation-in-part of application No. 17/982,884, filed on Nov. 8, 2022.

(51) Int. Cl. B65G 47/68; B65G 13/06; B65G 39/12; B65G 43/08

(52) U.S. Cl. CPC B65G 47/682; B65G 13/06; B65G 39/12; B65G 43/08; B65G 2201/0285; B65G 2203/0233; B65G 2203/0291; B65G 2203/044

(57) ABSTRACT

Singulating conveyors having transporting rollers are divided into multiple longitudinal zones in a forward or herringbone portion of the conveyor, preferably six or eight zones. Each longitudinal zone is divided into a pair of side-by-side outside and inside lateral zones. The rollers of each lateral zone are driven by a separate motor so that the speed of the rollers in the multiple longitudinal zones can vary along the herringbone portion, and the speed of the rollers in the outside lateral zones can operate at a higher speed than the rollers of the adjacent inside lateral zones. The discharge or skew portion of the conveyors is also divided into multiple longitudinal zones, preferably seven, each of which is driven by a separate motor so that the speed of the discharge rollers can be varied. The singulating conveyors can be expanded by utilizing a modular manufacturing method.

### CROSS-REFERENCE TO RELATED APPLICATIONS

This application is a Continuation-In-Part of pending application Ser. No. 17/982,884, filed Nov. 8, 2022, and also claims priority back to U.S. Provisional Application for Patent No. 63/281,283, filed Nov. 19, 2021.

### BACKGROUND OF THE INVENTION

### 1. Field of the Invention

This invention relates to singulating conveyors, and their method of operation, which conveyors can receive multiple packages, containers and parcels (hereinafter collectively “parcels”) in a random flow at one location adjacent the conveyor's entry end and transport the packages to a second location while at the same time organizing the parcels to exit in a single file at the conveyor's exit end.

### 2. Description of the Related Art

Conveyors are conventionally used to convey or transport items such as parcels of product in warehouses, manufacturing facilities and other locations. Typically, such facilities employ a conveyor distribution system that receives the parcels in a random flow for transport to a different location within the facility or location. However, it is desirable at some point during the conveyor distribution system to align the parcels into a single file for individual handling. Such alignment often is done by hand by workers at the facility, standing alongside at a convenient location or locations adjacent one or more conveyors.

Singulating conveyors have therefore been introduced into the marketplace in order to reduce the necessity for or number of workers to place the parcels in a desirable single file. One singulating conveyor has been marketed by Roach Manufacturing Corporation of Trumann, Arkansas (hereinafter “Roach”) under the trademark “Gator”. A copy of the Roach brochure directed to its “Gator” conveyor was submitted as part of the aforesaid U.S. Provisional Application for Patent No. 63/281,283, filed Nov. 19, 2021; the disclosure of the brochure is incorporated by reference herein as if fully set forth. Roach is the applicant and assignee of the present application and the invention disclosed herein.

The Roach “Gator” conveyor is able to reasonably singulate the transported parcels using increasing longitudinal speed zones in a herringbone pattern to drive two lanes of transporting rollers steered towards the center line of the conveyor. A top plan view drawing illustrating the rollers and images of the underneath dual motors and pulley systems for operating the four longitudinal speed zones of the Roach “Gator” conveyor is shown in FIG. 1 and marked with “Prior Art”. While the Roach “Gator” conveyor seeks to impart a single file order for the parcels being conveyed, the parcels tend to congregate, collect and bump up against each other (hereinafter collectively “congregate” or “congregation”) toward the center line of the conveyor as the parcels are transported along the four longitudinal speed zones.

Another singulating conveyor has been marketed by Lewco Inc., of Sandusky, Ohio, some features of which are disclosed in U.S. Pat. Nos. 9,981,804, 10,556,745 and 10,988,314.

Accordingly, a need exists for a singulating conveyor which is better able to organize random parcels into a single file order with a minimum of congregation as the parcels exit at the exit end of the conveyor.

### SUMMARY OF THE INVENTION

In order to improve the “congregation” problem described above, it has been surprisingly found that providing different speeds to the opposite sides of the lateral complementary left (“L”) and right (“R”) zones (looking from the entry end) of each of the longitudinal zones of the Roach “Gator” conveyor causes the parcels to form to a better straight-line configuration. The speed differential between the L and R lateral zones work in conjunction with increasing speeds of the longitudinal zones, from the first zone at the entry end of the conveyor toward the last zone near the exit end of the conveyor. In first preferred embodiments of the present invention (herein described as the Conveyor A embodiment, the Conveyor B embodiment, and the Conveyor C embodiment), there are four longitudinal zones 1, 2, 3 and 4 which, while working in conjunction with the L and R lateral zones, more effectively singulate the transported parcels. Each of the lateral zones L and R is preferably operated by utilizing a separate motor to each lateral zone, eight (8) motors in all counting each of the four longitudinal zones. Each motor can be controlled by its own separate variable speed controller, if desired by the user. Hence, each separate group or zone of conveying rollers, eight (8) in all, have speeds which vary both laterally and longitudinally along the conveyor. Alternatively, a pair of side-by-side motors, one for each of the L and R lateral sides, along with different ratio gearing assemblies, could be used to provide each of the eight respective longitudinal and lateral zones with the desired speed differentials.

The above-described singulating conveyors of the present invention include four longitudinal zones; however, a plurality of longitudinal zones could be used starting with only two and including more than four, so long as the longitudinal zones provide increasing speeds to the respective roller zones starting with the first zone adjacent the entry end of the conveyor and continuing toward the final zone at the exit end of the conveyor.

Additionally, the speed of the final longitudinal zone is increased or decreased from the speed of its next preceding longitudinal zone based on the speed desired for the singulated parcels to exit the conveyor.

More recently, it has been found that by increasing the number of longitudinal zones in the forward or herringbone portion of the conveyors of the present invention from the four (4) zones of the first preferred embodiments, further customization of the speeds ratios between zones allows for even better singulation. Further, it has also been found that splitting the discharge or skew portion of the conveyors into a plurality of separate longitudinal zones allows for variation in speeds between the discharge zones for even better singulation.

Accordingly, in second preferred embodiments of the present invention, the singulating conveyors include more than four (4) longitudinal zones in the forward or herringbone portion of the conveyor, preferably six (6) or eight (8) longitudinal zones, each of the six (6) or eight (8) longitudinal zones having a pair of L and R lateral zones. These two preferred singulating conveyors are described herein as the Conveyor D embodiment and the Conveyor E embodiment, respectively. The discharge or skew portion of the Conveyor D embodiment and the discharge or skew portion of the Conveyor E embodiment are preferably the same and are preferably divided into seven (7) additional separate longitudinal zones.

Each of the six (6) lateral zones L and R of the herringbone portion of the Conveyor D embodiment is operated by utilizing a separate motor for each lateral zone, twelve (12) motors in all counting each of the six (6) longitudinal zones. Each of the eight (8) lateral zones L and R of the herringbone portion of the Conveyor E embodiment is also operated by utilizing a separate motor for each lateral zone, sixteen (16) motors in all counting each of the eight (8) longitudinal zones.

Each of the seven (7) separate additional longitudinal zones of the skew portion of these conveyors is also operated by utilizing a separate motor for each separate longitudinal zone, seven (7) motors in all. Thus, there are nineteen (19) motors in all for the Conveyor D embodiment and twenty-three (23) motors in all for the Conveyor E embodiment, and each motor can be controlled by its own separate variable speed controller, if desired by the user.

Hence, each separate group of rollers or zone in the herringbone portion of the Conveyor D embodiment, twelve (12) in all, has speeds which vary both laterally and longitudinally along the conveyor. Similarly, each separate group of rollers or zone in the herringbone portion of the Conveyor E embodiment, sixteen (16) in all, has speeds which vary both laterally and longitudinally along the conveyor. In both the Conveyor D embodiment and Conveyor E embodiment, each of the seven (7) separate groups of rollers or zones in the skew portion also have speeds which vary longitudinally along the conveyors.

Further, it has also been found that in the Conveyor D embodiment and the Conveyor E embodiment, with all zones having different speed capabilities in both the herringbone portion and the skew portion, it is not always necessary or desirable that the speed of the rollers in each longitudinal zone increase sequentially from the entrance end and toward the exit end of the conveyor. As will be described in more detail hereinafter, rather, it may be desirable to have some adjacent longitudinal zones operate at the same speed while other adjacent zones can be operated at a higher speed or a lower speed as may be helpful in singulating the parcels in a single file as they approach the end or exit end of the conveyor.

As will be described in more detail hereinafter, the position of the motors in the second preferred embodiments is different from the positioning of the motors in the first preferred embodiments, and the second preferred embodiments also utilize a different drive mechanism whereby the torque created by of the motors is transferred to their respective conveyor rollers.

The singulating conveyors of the present invention include a horizontal framework which supports each group of conveying rollers, as well as the motors and drive systems underneath. The lateral L and R rollers are skewed toward the center in a herringbone fashion and divided into the series of longitudinal zones, which are driven in increasing speeds from the entrance end toward the exit end of the conveyor. As is conventional, the framework and rollers are supported from the floor at a desired height by reinforced stanchions.

More specifically, the singulating conveyors of the present invention include two sets of lateral rollers at the feed end, or entrance, of the conveyor. The rollers in each zone of the conveyor are in parallel alignment, but skewed at an angle with the outer end of the rollers being forward compared to the inner end of the rollers. This skewing causes the parcels to be driven towards the center line of the conveyor. The group of rollers on the R side of the conveyor continues to the exit end, i.e., the discharge rollers, of the conveyor while maintaining the angle of the rollers. This angling of the discharge rollers at the exit end moves the parcels from the center or center line of the conveyor to the left side (when looking down the conveyor entry or feed end). Alternatively, the conveyor can be arranged in order to move the parcels to the other side of the exit, by having the L side rollers continue to the exit, rather than the R side rollers. Generally, the lateral side of the rollers (R side or L side) which includes the discharge rollers is considered to represent the “outside” lateral zones and the other side, the “inside” lateral zones.

Preferably, the rollers in each outside lateral zone operate at a selected higher speed than the rollers in its corresponding and adjacent inside lateral zone, except perhaps the last outside lateral zone that includes the discharge rollers. Further, a portion of the rollers of some outside lateral zones preferably have a higher coefficient of friction than the rollers of the corresponding and adjacent inside lateral zones. The higher coefficient of friction of the rollers in the outside lateral zones can conventionally be achieved by utilizing standard friction coverings known in the art and available commercially. A preferred conventional friction covering is ⅛ inch thick polyurethane.

The rollers in the first preferred embodiments of the present invention are driven by a V-Belt drive system mounted underneath the rollers and supported from the horizontal framework. Each group of rollers, preferably eight (8) zones in total including two lateral zones in each of four longitudinal zones, has its own V-Belt drive system. Each of the V-Belt drive systems are set in motion by each respective separate motor (8 in total), and a gear reducer turns a drive shaft which in turn drives a drive sheave at one end of the V-belt. The V-Belt drive system includes a supporting sheave horizontally spaced from the drive sheave to support the outer end of the V-belt and intermediate pulleys underneath the drive section of the V-belt. These sheaves and pulleys provide sufficient pressure so that the upper course of the V-belt presses against the bottom of the transporting rollers to thus drive the rollers in each zone of the conveyor. The rollers are located longitudinally using vertically elongated hex holes, which allow the bottom of the transporting rollers to more easily match the upper course of the V-belt, and vertically by specially designed brackets, which limit how high the rollers can travel in the vertically elongated hex holes. Since each V-Belt drive system has a separate motor, the speed of the transporting rollers in each of the eight zones can be selected and controlled independently of each other.

Alternatively, a single pair of motors could be utilized similar to the Roach “Gator” conveyor. However, in such an arrangement, the two sheaves in each V-Belt drive system have to be individually sized in order to secure the desired speeds for each of the eight zones in a four longitudinal zone conveyor. However, once established with separately sized sheaves, the speeds established for each zone can only be somewhat varied in that a variable speed drive controller can be connected to each motor. The zone speeds on the R side will increase or decrease together by the ratios established by their corresponding sheaves. Similarly, the zone speeds on the L side will increase or decrease together by the ratios established by their corresponding sheaves. The only way to achieve greater variance is by substituting sheaves.

In the second preferred embodiments of the present invention, the Conveyor D embodiment and the Conveyor E embodiment, each separate group of rollers or zones is driven by a separate motor, nineteen (19) or twenty-three (23) motors in all, respectively.

The motors are preferably mounted underneath the rollers of their respective zones and supported from the horizontal framework adjacent the outer edge on each side of the framework and positioned at an angle similar to the skewed angle of the rollers. A drive sheave is mounted on each motor shaft and includes two side-by-side grooves, each of which engages a complementary drive band. Each drive band is tensioned around a complementary groove towards the outer end of adjacent drive rollers. The remaining rollers of each conveyor group or zone, the driven rollers, are interconnected to the drive rollers and to each other by a series of power roller belts, which engage complementary grooves also on the outer ends of adjacent rollers.

Accordingly, it is an object of the present invention to provide a singulating conveyor which better addresses the problem of congregation of the conveyed parcels so that the parcels form a better single-file configuration at the exit end of the conveyer.

It is another object of the present invention to provide a singulating conveyor having a plurality of longitudinal zones in a herringbone pattern with the speed of the rollers in each longitudinal zone increasing from the entrance end toward the exit end of the conveyor, while simultaneously providing different speeds to the complementary lateral L and R zones of each of the longitudinal zones.

It is a further object of the present invention to provide a singulating conveyor in accordance with the preceding object in which there are preferably four longitudinal zones of increasing speeds, thus with the different speeds of the lateral L and R zones making a total of eight different roller groups potentially having different variable speeds.

It is a further object of the present invention to provide a singulating conveyor in accordance with the preceding object in which the last longitudinal zone speed is increased or decreased to achieve the desired exit speed of the parcels.

It is a still further object of the present invention to provide a singulating conveyor in accordance with the preceding object in which each of the eight groups of rollers is driven by a separate motor and respective V-Belt drive system.

Yet another object of the present invention is to provide a singulating conveyor having six (6) or eight (8) longitudinal zones in the forward or herringbone portion of the conveyor, with the speed of the rollers in each longitudinal zone varying from the entrance end and toward the exit end of the conveyor, while simultaneously providing different speeds to the complementary lateral L and R zones of each of the longitudinal zones.

Still another object of the present invention is to provide a singulating conveyor in accordance with the preceding object in which the discharge or skew portion of the conveyor includes seven (7) separate groups of rollers or zones to exit the conveyed parcels on either side of the conveyor.

Still a further object of the present invention is to provide a singulating conveyor in accordance with the two preceding objects in which each of the nineteen (19) or twenty-three (23) groups of rollers or zones is driven by a separate motor and respective drive sheave and complementary drive bands and drive belts.

A further object of the present invention is to provide a method of manufacturing multiple singulating conveyors in a modular fashion to improve inventory control, simplification of the manufacturing process, and operational flexibility.

Another object of the present invention is to provide a method for operating a singulating conveyor having a plurality of longitudinal zones in a herringbone pattern in which the speed of the rollers in each longitudinal zone can vary from the entrance end toward the exit end of the conveyor, while at the same time simultaneously operating the rollers in the outside lateral zones at a higher speed than the rollers in the corresponding and adjacent inside lateral zones, except perhaps the last outside lateral zone that includes the discharge rollers.

Another object of the present invention is to provide a method for operating a singulating conveyor in accordance with the preceding object in which there are preferably four longitudinal zones operated at increasing speeds, thus with different speeds of the outside and inside lateral zones making a total of eight different roller groups potentially operated at different variable speeds.

Yet another object of the present invention is to provide a method for operating a singulating conveyor in accordance with the preceding object in which the outside lateral zone which includes the discharge rollers is operated at an increased or decreased speed to achieve the desired exit speed of the parcels from the conveyor.

Still another object of the present invention is to provide a method for operating a singulating conveyor having preferably six (6) or eight (8) longitudinal zones in the forward or herringbone portion of the conveyor, in which the speed of the rollers in each longitudinal zone can vary from the entrance end toward the exit end of the conveyor, while at the same time simultaneously operating the rollers in the outside lateral zones at a higher or equal speed than the rollers in the corresponding and adjacent inside lateral zones.

Yet a further object of the present invention is to provide a method for operating a singulating conveyor in accordance with the preceding object in which the six (6) or eight (8) longitudinal zones together with the respective lateral zones are capable of operating at different speeds making a total of twelve (12) or sixteen (16) different lateral groups in the herringbone portion of the conveyor potentially operated at different variable speeds.

Still a further object of the present invention is to provide a method for operating a singulating conveyor in accordance with the preceding two objects, in which the skew portion of the conveyor includes a plurality, preferably seven (7), longitudinal zones operated at different speeds, increasing or decreasing in order to achieve a desired singulation and exit speed of the parcels from the conveyor.

Other objects, features, and advantages of the present invention will become apparent to those skilled in the art based upon the disclosure provided herein.

### BRIEF DESCRIPTION OF THE DRAWINGS

FIG. 1 is a top plan view of the prior art Roach “Gator” singulating conveyor showing the roller groups in side-by-side lateral zone pairs and four longitudinal zones arranged in a herringbone pattern together with images of the two motors and related drive systems mounted beneath the rollers.

FIG. 2 is a schematic top plan view of a first preferred singulating conveyor embodiment in accordance with the present invention with four longitudinal zones, each divided into a pair of lateral side-by-side L (inside) and R (outside) zones, all arranged in a herringbone pattern and showing a random pattern of parcels entering the conveyor at the right and the parcels in a single file exiting the conveyor at the left.

FIG. 3 is a top plan view of a first preferred singulating conveyor embodiment in accordance with the present invention (the Conveyor A embodiment) including four longitudinal zones of rollers and the complementary inside and outside pairs of lateral L and R zones, along with images of the eight motors and associated V-Belt drive systems operating underneath the eight variable speed zones of the conveyor.

FIG. 4 is a left side elevation view of the Conveyor A embodiment shown in FIG. 3, but without the related V-belt drive systems.

FIG. 5 is a front-end elevational view of the singulating conveyor shown in FIG. 3.

FIG. 6 is a top view of one of the motors and related V-Belt drive system for driving seven of the eight conveying roller zones of the conveyor shown in FIG. 3.

FIG. 7 is a side elevation view of the V-Belt drive system, with the associated motor hidden for clarity, for the seven of eight roller zones shown in FIG. 6.

FIG. 8 is a side elevation view of the V-Belt drive system and associated motor similar to FIG. 7 but also includes the transporting rollers in engagement with the top side of the V-belt for driving the rollers.

FIG. 9 is a top plan view of the motor and related V-Belt drive system for the off-ramp zone of rollers at the exit end of the conveyor shown in FIG. 3.

FIG. 10 is a side elevation view of the V-Belt drive system shown in FIG. 9, with the associated motor hidden for clarity.

FIG. 11 is an enlarged view of the first and second right hand (R) longitudinal zones shown in FIG. 3.

FIG. 12 is a top plan view of another first preferred singulating conveyor embodiment in accordance with the present invention (the Conveyor B embodiment) including four longitudinal zones of rollers and complementary inside and outside pairs of lateral L and R zones, along with images of the eight motors and associated V-Belt drive systems operating underneath the eight variable speed zones of the conveyor.

FIG. 13A is a left side elevational view of the Conveyor B embodiment shown in FIG. 12, but without the related V-Belt drives systems.

FIG. 13B is an enlarged side view of an upper section of the conveyor side channel shown in FIG. 13A.

FIG. 13C is an enlarged side view of one of the specially designed hold-down brackets (overlayed on the FIG. B section), which brackets limit how high the rollers can travel in vertically elongated hex holes in the Conveyor B embodiment.

FIG. 14 is a left side, front end perspective view of the Conveyor B embodiment, again showing the left side conveyor side channel and the specially designed brackets illustrated in FIGS. 13A, 13B, and 13C.

FIG. 15 is a front end elevational view of the conveyor shown in FIG. 12.

FIG. 16A is a top view of one of the motors and related V-Belt drive system for driving seven of the eight conveying roller zones of the Conveyor B embodiment shown in FIG. 12.

FIG. 16B is a side elevation view of the V-Belt drive system, with associated motor hidden for clarity, for the seven of eight roller zones shown in FIG. 16A.

FIG. 17 is a side elevational view of the V-Belt drive system for the off-ramp zone of rollers at the exit end of the conveyor shown in FIG. 12, with the associated motors hidden for clarity.

FIG. 18 is a top plan view of another first preferred embodiment of a singulating conveyor in accordance with the present invention (the Conveyor C embodiment).

FIG. 19A is a top plan view of a second preferred singulating conveyor embodiment in accordance with the present invention (the Conveyor D embodiment), with the band guards omitted, including six (6) longitudinal zones of rollers in a forward portion of the conveyor, with the complementary inside and outside pairs of L and R zones, indicated as L1-L6 lateral zones, inclusive, and R1-R6 lateral zones, inclusive, and seven (7) separate additional longitudinal zones comprising the discharge end of the conveyor, indicated as discharge longitudinal zones 7-13, inclusive.

FIG. 19B is a top plan view of another second preferred singulating conveyor embodiment in accordance with the present invention (the Conveyor E embodiment), with the band guards omitted, including eight (8) longitudinal zones of rollers in a forward portion of the conveyor, with the complementary inside and outside pairs of L and R zones, indicated as L1-L8 lateral zones, inclusive, and R1-R8 lateral zones, inclusive, and seven (7) separate additional longitudinal zones comprising the discharge end of the conveyor, indicated as discharge longitudinal zones 9-15, inclusive.

FIG. 19C is a left side, front end exploded perspective view of the Conveyor E embodiment showing how the first four (4) longitudinal zones in a first modular conveyor section and the last two (2) longitudinal zones of the forward portion of the conveyor and the discharge zone of the conveyor in a second modular conveyor section can be the same for both the Conveyor D embodiment and the Conveyor E embodiment, while a third modular conveyor section, including two (2) additional longitudinal zones, can comprise zones 5 and 6 in the Conveyor E embodiment.

FIG. 20A is a top plan view of the conveyor framework for the Conveyor D embodiment (without the rollers) showing the positioning of the twelve (12) motors in the forward portion of the conveyor, six (6) each supported adjacent the outer edge on each side of the conveyor framework, and the seven (7) motors which drive the seven (7) longitudinal zones of the discharge end of the conveyor, with one (1) motor on the R side of the conveyor and six (6) motors on the L side of the conveyor.

FIG. 20B is a top plan view of the conveyor framework for the Conveyor E embodiment (without the rollers) showing the positioning of the sixteen (16) motors in the forward portion of the conveyor, eight (8) each supported adjacent the outer edge on each side of the conveyor framework, and the seven (7) motors which drive the seven (7) longitudinal zones of the discharge end of the conveyor, with one (1) motor on the R side of the conveyor and six (6) motors on the L side of the conveyor.

FIG. 21 is a left side elevational view of the Conveyor D embodiment of FIGS. 19A and 20A, showing the motor location of the six (6) motors along the L side in the forward portion of the conveyor and the six (6) motors on the L side, which power the rollers in the last six (6) longitudinal zones of the discharge end of the conveyor.

FIG. 22 is a front end elevational view of the singulating conveyor shown in FIGS. 19A and 20A, showing in place the optional guard rails along each longitudinal side of the conveyor.

FIG. 23A is a left side, front end perspective view of the Conveyor D embodiment, showing in place the optional guard rails along each longitudinal side of the conveyor and highlighting frictional coverings on three (3) rollers of each of three (3) outer lateral zones identified as R-2, R-4 and R-6.

FIG. 23B is a right side, front end perspective view of the Conveyor D embodiment of FIG. 23A, showing an optional parcel guide along the left hand (or L side) of the discharge end of the conveyor.

FIG. 24A is a right side, perspective view of the Conveyor D embodiment, with the band guards omitted, showing the location of the six (6) motors driving the six (6) longitudinal R1-R6 zones in the forward portion of the conveyor and the single motor (far right motor) driving the initial longitudinal zone (zone 7) of the discharge end of the conveyor, along with a cut-out portion in the front left side of the conveyor, which is enlarged in FIG. 24.

FIG. 24B shows one (1) motor sheave and two (2) drive bands interconnecting the motor and two (2) adjacent rollers, along with power roller belts interconnecting the drive rollers to the driven rollers. Note that a portion of the rollers has been cut away in order to expose the foregoing description.

FIG. 25A is a left side, front end perspective view of the Conveyor D embodiment, with the band guards omitted, showing the six (6) motors which drive the six (6) longitudinal L1-L6 zones in the front portion of the conveyor and the six (6) motors driving the last six (6) longitudinal zones (zones 8-13) of the discharge end of the conveyor, along with a cut-out portion in the front left side of the conveyor, which is enlarged in FIG. 25.

FIG. 25B shows one (1) skewed motor along with its related controller and ethernet module and power roller belts interconnecting the drive rollers with the driven rollers.

FIG. 26 is an enlarged view showing a series of power roller belts which interconnect driven rollers adjacent their outer ends in the Conveyor D embodiment.

FIG. 27A is a left-side, front end perspective view of the Conveyor D embodiment, similar to FIG. 23A, showing optional photoeyes installed along the R side band guard that can sense when there is a large amount of product (parcels) moving in a zone in a small interval of time, which is enlarged in FIG. 27B, to better show the location of the photoeyes.

FIG. 28 is a top plan view of the Conveyor D embodiment showing multiple rollers with frictional coverings, the L side and R side band guards and the optional guard rails, and an optional parcel guide along the L side of the discharge portion of the conveyor.

### DETAILED DESCRIPTION OF THE PREFERRED EMBODIMENTS

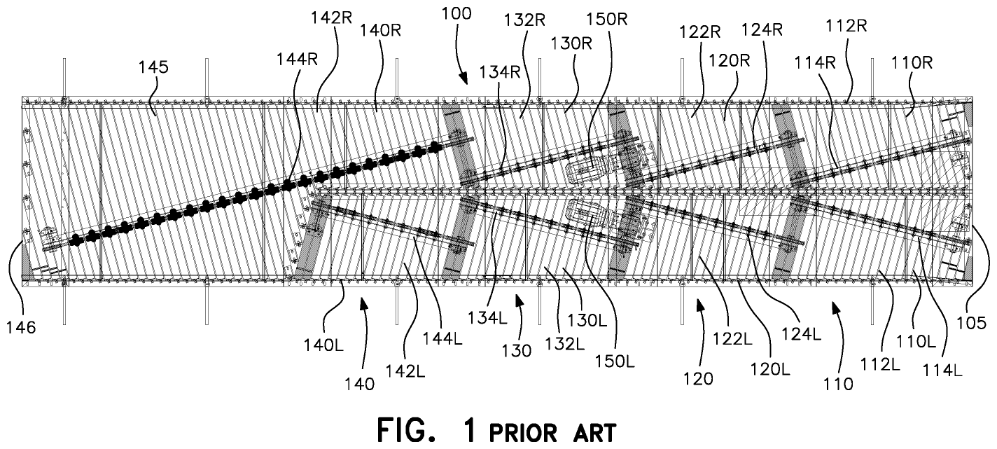

Turning first to the prior art Roach “Gator” conveyor shown in FIG. 1, the singulating conveyor is generally designated by reference number 100. The conveyor 100 is divided into four longitudinal zones, starting with the first zone 110 at the entrance or feed end 105 of the conveyor and continuing with succeeding longitudinal zones generally designated by reference numerals 120, 130 and 140, respectively. Each longitudinal zone is divided into two side-by-side inside and outside lateral zones 110 L and 110 R, 120 L and 120 R, 130 L and 130 R, and 140 L and 140 R, respectively. The left and right hand designated lateral zones are determined by looking down the conveyor from the entry or feed end 105.

Each of the eight zones 110 L, 110 R, 120 L, 120 R, 130 L, 130 R, 140 L and 140 R include a series of conveying or transporting rollers 112 L, 112 R, 122 L, 122 R, 132 L, 132 R, 142 L and 142 R, respectively. These rollers are in parallel alignment, but skewed at an angle with the outer end of the rollers being forward compared to the inner ends of the rollers. As shown, the rollers 142 R continue beyond the end of zone 140 L, at 145 and continue to the exit end 146 of the conveyor 100. This continuation of rollers 142 R causes the parcels to move from the center or center line of the conveyor to the left side at the conveyor exit end.

As shown in FIG. 1, the conveyor 100 incudes a pair of side-by-side motors 150 L and 150 R which drive eight interconnected drive systems 114 L, 114 R, 124 L, 124 R, 134 L, 134 R, 142 L and 144 R, which in turn drive the respective transporting rollers 112 L, 112 R, 122 L, 122 R, 132 L, 132 R, 142 L and 142 R. The two motors 150 and associated pulley drive systems 114, 124, 134 and 144 are configured so that the conveying rollers 112, 122, 132 and 142 are driven at successively increasing speeds across each of the four zones 110, 120, 130 and 140. However, the respective left (L) and right (R) lateral zones are driven at the same speed in each longitudinal zone.

As will be seen, there are herein disclosed first and second preferred embodiments of singulating conveyors in accordance with the present invention: the first preferred embodiments include the Conveyor A embodiment, the Conveyor B embodiment, and the Conveyor C embodiment; and the second preferred embodiments include the Conveyor D embodiment and the Conveyor E embodiment.

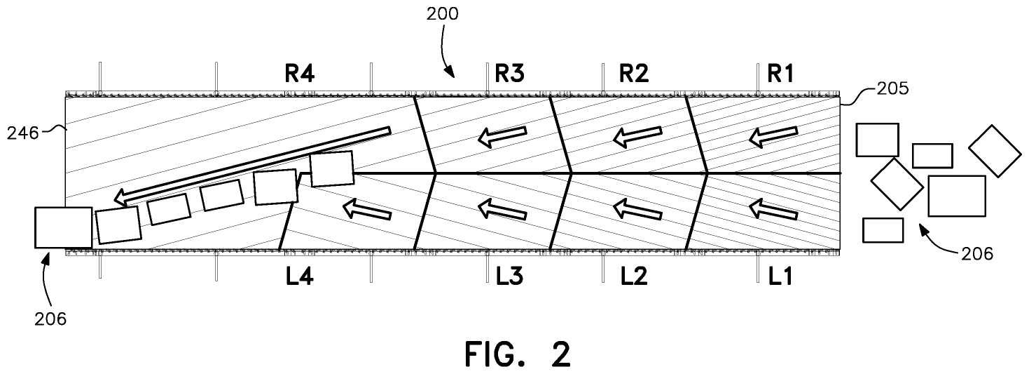

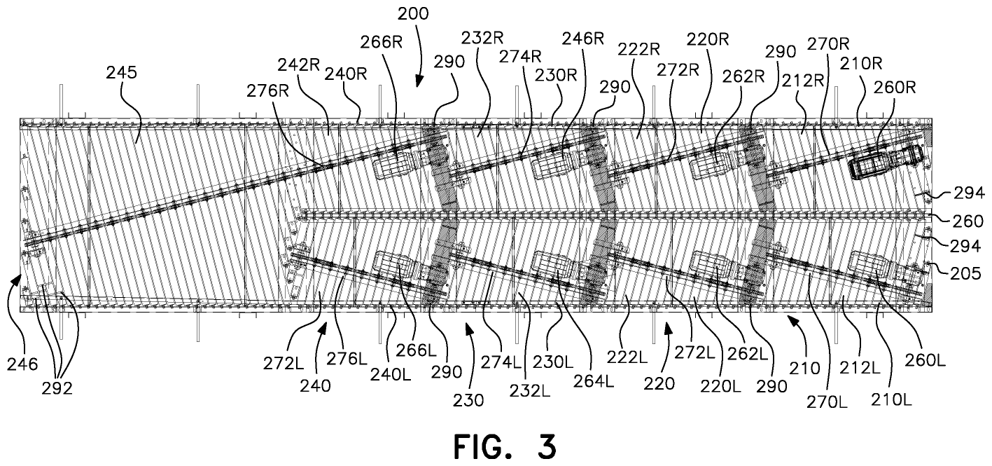

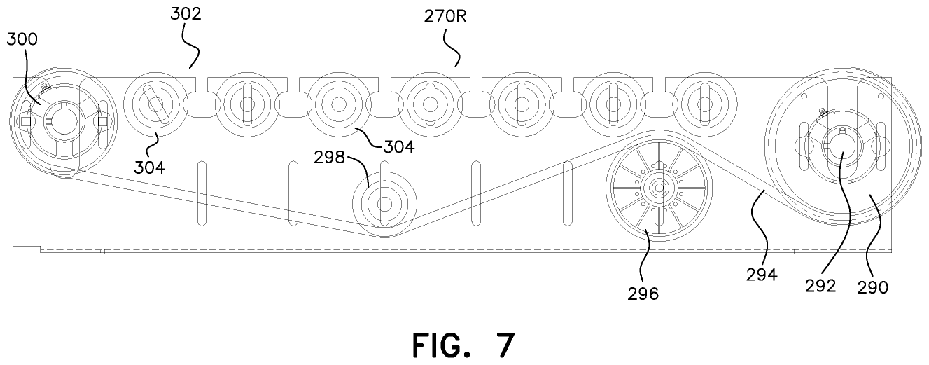

Turning now to FIG. 2, a schematic top plan view of the first preferred singulating conveyors in accordance with present invention, generally designated by reference numeral 200, is shown. As shown, the singulating conveyor 200 includes four longitudinal zones, each including a pair of side-by-side lateral zones, each marked L1, L2, L3 and L4 for the left side longitudinal zones 1 through 4, and R1, R2, R3 and R4 for the right hand side of the longitudinal zones 1 through 4. A random array of parcels, generally designated by reference numeral 206 are shown entering the entrance end 205 of conveyor 200, and the same parcels 206 are shown exiting in single file at the exit end 246 of conveyor 200. The details of the Conveyor A embodiment is described hereinafter in greater detail in connection with FIGS. 3-11.

Turning now to FIGS. 3, 4 and 5 where like components of the singulating conveyor 200 of the present invention are the same as in the singulating conveyor 100 shown in FIG. 1, the numerals are the same except the series “200” has been used instead of the series “100”. The conveyor 200 is divided into the preferred four longitudinal zones, generally designated by reference numerals 210, 220, 230 and 240, which are driven at increasing speeds from the first zone 210 at the entrance end 205 of the conveyor toward the fourth zone 240 at the exit end 246. The speed of the fourth zone 240 is increased or decreased relative to zone 230 as needed to select the desired exit speed of the parcels. While four longitudinal zones are preferred, a plurality of longitudinal zones can be used in accordance with the present invention, including only two, or more than four, so long as the longitudinal zones provide increasing speeds to the respective conveyor rollers in each zone starting with the first zone adjacent end 205 and increasing toward the final zone at exit end 246. The speed of the final zone of the plurality of longitudinal zones is increased or decreased relative to the adjacent preceding longitudinal zone as needed to select the desired exit speed of the parcels.

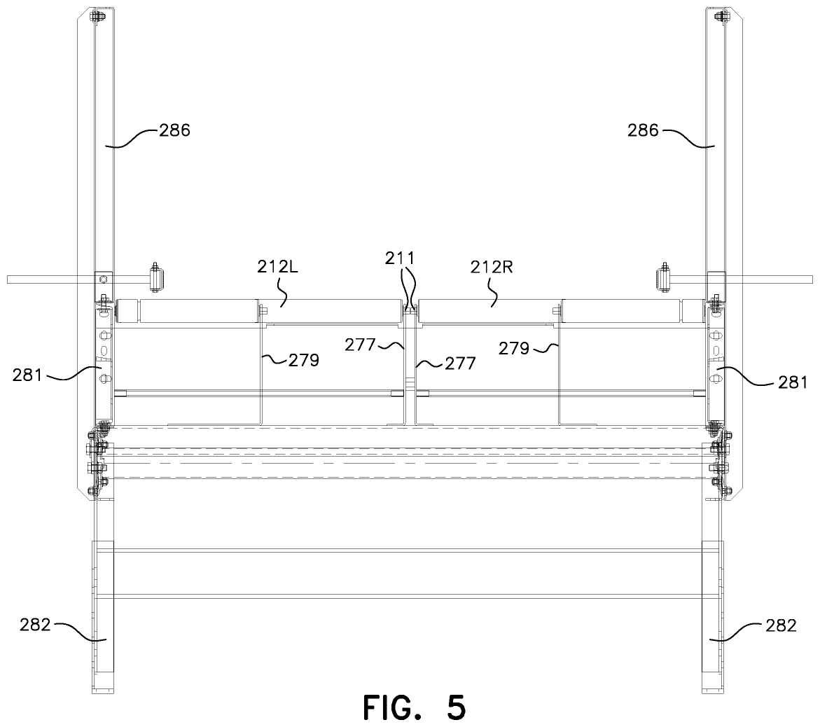

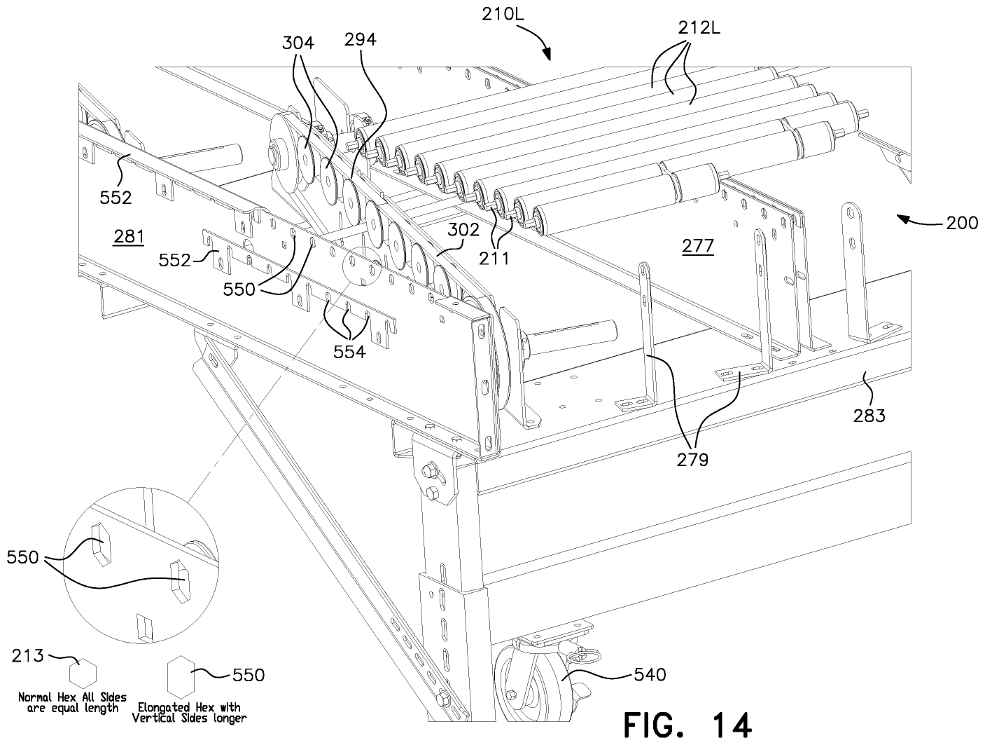

Each of the longitudinal zones includes a pair of side-by-side lateral zones designated left (L) and right (R), thus forming four outside lateral zones 210R, 220R, 230R and 240R, and four inside lateral zones 210L, 220L, 230L and 240L. Each lateral zone of each longitudinal zone, eight (8) in total, includes a series of transporting rollers 212 L, 212 R, 222 L, 222 R, 232 L, 232 R, 242 L and 242 R. The rollers in each zone of conveyor 200 are in parallel alignment, but skewed at an angle with the outer end of the rollers being forward compared to the inner end of the rollers. The skewing causes the transported parcels to be driven towards the center line 260 of the conveyor. In a preferred configuration, the parallel rollers in each lateral zone are skewed forwardly at an angle of about 76 degrees from the center line of the conveyor, but the skewed angle can vary as much as +/−ten percent (10%). As shown FIG. 5, the rollers have conventional supporting hexagonal (hex) axles 211 which are located in corresponding mating hex holes 213 in side channels 281 (illustrated schematically in the lower left-side portion of FIG. 14) and center ribs 277 of the framework 280, except the shortened rollers at various locations along the conveyor, which have one axle end supported by L-brackets 279 (see FIG. 5, for example, at the front end of the conveyor). The shortened rollers can be seen in FIG. 3 at the front end of the conveyor, the rear end of the conveyor and about midway in zone 240.

As shown in FIG. 3, the group of rollers 242 R extend beyond the end of the zone 240 L, i.e., the discharge rollers 245, and the discharge rollers 245 continue to the exit end of the conveyor while maintaining the roller angle. This angling of the rollers at the exit end moves the parcels from the center or center line of the conveyor to the left side. If desired to have the parcels exit to the right hand side of the conveyor, the length of zones 240 L and 240 R can be reversed so that rollers 242 L extend to the exit end 246 of the conveyor, and the rollers 242 R will terminate where the rollers 242 L are shown terminating in FIG. 3.

In the embodiment shown in FIG. 3, the lateral zones on the R side of the conveyor which includes discharge rollers 245 at the exit end 246 are considered the outside lateral zones and the lateral rollers on the L side of the conveyor are considered the inside lateral zones. If the exit end 246 were reversed to include the lateral zone 242 L, then the lateral zones on the L side of the conveyor would be considered the outer lateral zones and the lateral zones on the R side of the conveyor would be considered the inner lateral zones.

In accordance with the present invention, the conveyor 200 is designed so that the transporting rollers in each of the eight lateral and longitudinal zones can be driven independently and separately at variable and different speeds. Surprisingly, if the opposite sides of the lateral complementary left (L) and right (R) zones of each longitudinal zone is provided with different speeds, the parcels conveyed by the conveyor 200 form a better straight-line configuration at the exit end 246. To this end, each of the eight zones is provided with separate motors 260 L and 260 R for zone 210, 262 L and 262 R for zone 220, 264 L and 264 R for zone 230 and 266 L and 266 R for zone 240. Each of the motors 260 L and R, 262 L and R, 264 L and R, and 266 L and R drive separate and individual V-Belt drive systems 270 L and R, 272 L and R, 274 L and R and 276 L and R, respectively. Each of the eight motors are the same and seven of the V-Belt drive systems 270 L and R, 272 L and R, 274 L and R, 276 L and R are the same. Drive system 276 R is extended beyond zone 240 L and continues to the exit end 246 of the conveyor 200, as shown by discharge rollers 245, so that the parcels exit on the left side (or inner side) of conveyor 200.

Preferably, the rollers 212 R, 222 R, 232 R and 242 R of each of the outside lateral zones are driven at a selected faster speed than the corresponding rollers 212 L, 222 L, 232 L and 242 L of each of the adjacent inside lateral zones. Further, the coefficient of friction for a portion of the rollers in a plurality of the outside lateral zones is greater than that for the rollers in the corresponding and adjacent inside lateral zones. This higher coefficient of friction can be achieved by covering at least some of the rollers in the outside lateral zones with standard ⅛ inch thick friction polyurethane coverings which are available commercially from Spiratex of Romulus, Michigan. Similar polyurethane roller sleeves are available from Kastalon Polyurethane Products of Alsip, Illinois, and conveyor roller covers and coatings are available from C & M Coatings, Inc of Grand Haven, Michigan.

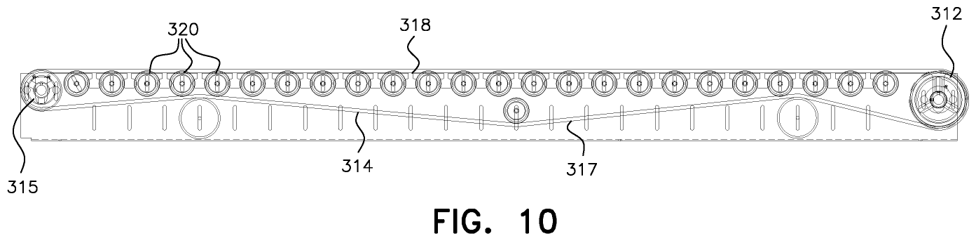

Further, there are a few of the transporting rollers in each zone where the V-Belt drive system cannot contact the rollers. In such circumstances, the rollers are connected by bands 261 to provide for their rolling action. The bands (dark lines) can be seen in FIG. 3 in each of the shaded areas marked with the numeral 290 (near the center line 260), along with bands 292 at the lower far left of the conveyor and bands 294 at the center far right of the conveyor. The bands 261 and 294 are best seen in FIG. 11.

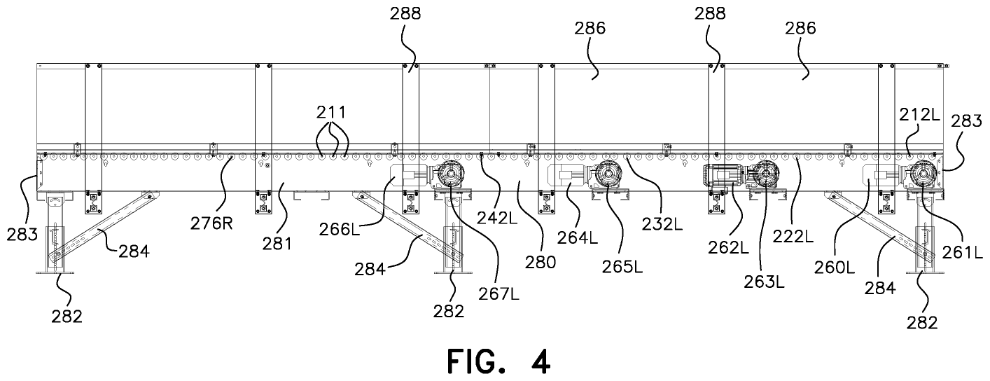

The transporting rollers and motors 260L, 262L, 264L and 266L are mounted on a horizontal framework 280 as shown in FIG. 4. The framework 280 includes side channels 281 on each of the left and right sides of the conveyor (see FIG. 5) and end channels 283 at the front and back ends of the conveyor. Although not shown in FIG. 4, the framework 280 also supports the V-Belt drive systems 270 L and R, 272 L and R, 274 L and R and 276 L and R. The framework 280, as well as the rollers, motors, and drive systems, is supported from the floor at a desired height by reinforced stanchions 282 and angle braces 284. Extending upwardly from the side channels 281 along each side of the framework 280 are a series of side panels 286. The side panels 286 extend along the full length of the conveyor 200 and are supported by vertical support brackets 288.

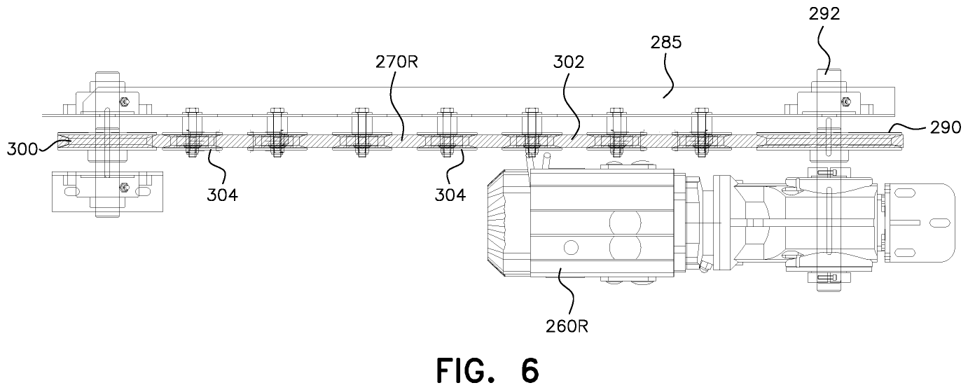

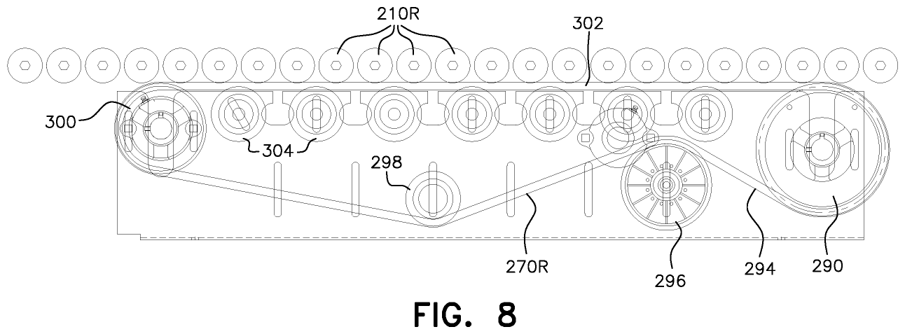

Turning next to FIGS. 6, 7 and 8, a representative motor 260 R and associated V-Belt drive system 270 R are shown as illustrative of the seven zones 210 L and R, 220 L and R, 230 L and R and 240 L. Motor 260 R is connected to a gear reducer which drives shaft 292. Drive sheave 290 is mounted on drive shaft 292. A V-belt 294 is engaged around drive sheave 290 and extends around horizontally spaced support sheave 300. The V-belt 294 also extends over tension pulley 296 and underneath tension pulley 298. The upper horizontal extent 302 of V-belt 294 between drive sheave 290 and support sheave 300 is supported by a series of intermediate pulleys 304. As shown in FIG. 8, the upper surface of the V-belt horizontal extent 302 is pressed up against the lower surface of transporting rollers 210 R. As such, the V-belt is squeezed between the drive and supporting sheaves and the rollers so that when the V-belt is in motion, the friction between the V-belt and the rollers causes the transporting rollers to turn. Other drive systems besides this specific V-Belt drive system disclosed herein could be utilized without the departing from the present invention.

As shown in FIGS. 4 and 6, the motors 260L, 262L, 264L and 266L are supported on motorbases 261L, 263L, 265L and 267L, respectively. The V-Belt drive system 270R is supported on the sheave support angle 285 of the framework 280. In the Conveyor A embodiment (as shown in FIG. 6), the V-Belt drive system 270R is positioned between the motor 260R and the sheave support angle 285.

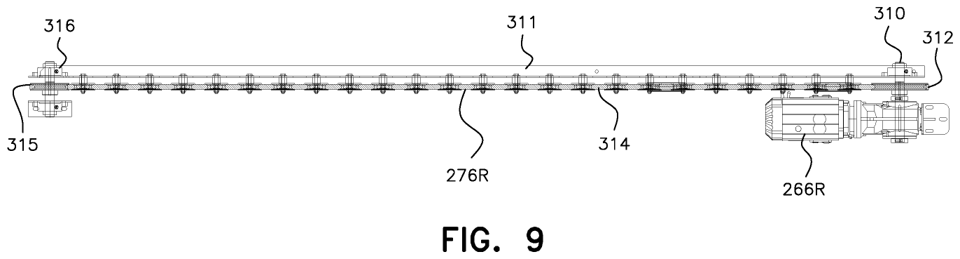

The motor 266 R and associated drive system 276 R for zone 240 R are shown separately in FIGS. 9 and 10. The drive system 276R is similarly supported on sheave support angle 311 between the motor 266R and the sheave support angle 311. The motor 266 R is connected to a gear reducer which drives shaft 310. Drive sheave 312 is mounted on drive shaft 310 and engages the V-belt 314. V-belt 314 extends around horizontally spaced support sheave 315 which is mounted adjacent the exit end 246 of the conveyor 200 by bracket 316. The lower portion 317 of the V-belt 314 also extends over and under tension pulleys similar to that described for V-belt 294 in FIGS. 6, 7 and 8. The upper horizontal extent 318 of the V-belt 314 between drive sheave 312 and support sheave 315 is also supported by a series by an intermediate pulleys 320. The upper surface of the horizontal extent 318 of V-belt 314 also engages the under surface of the transporting rollers 242 R and 245 of zone 240 R in the same manner as described and illustrated in connection with FIG. 8.

Next, turning to FIG. 11, an enlarged view of zones 210 R and 220 R, taken from FIG. 3 is shown. More specifically, it has been found that singulation of the parcels can be enhanced if some of the rollers have a friction enhancing covering applied to their outer surface, as previously described. This is particularly advantageous for rollers in the outer lateral zones of the first and second longitudinal zones as shown for the Conveyor A embodiment, which zones have a higher speed relative to that zone's mating inner lateral zone. Hence for the Conveyor A embodiment described herein, the friction covering is preferably applied to a portion of rollers 210 R and 220 R. While not intended to be bound by specific rollers, it has been found that applying a frictional covering to the three rollers 322 in zone 210 R and the three rollers 324 in zone 220 R, is beneficial to singulating the parcels by conveyor 200 as described herein. More recently, it has been found that the friction covering can preferably be applied to a portion of rollers 210R, 220R, and 230R, as hereinafter described in connection with the Conveyor B embodiment. By applying frictional coverings to four rollers in zone 210R, four rollers in zone 220R and four rollers in zone 230R, a more beneficial singulation of the parcels may be achieved.

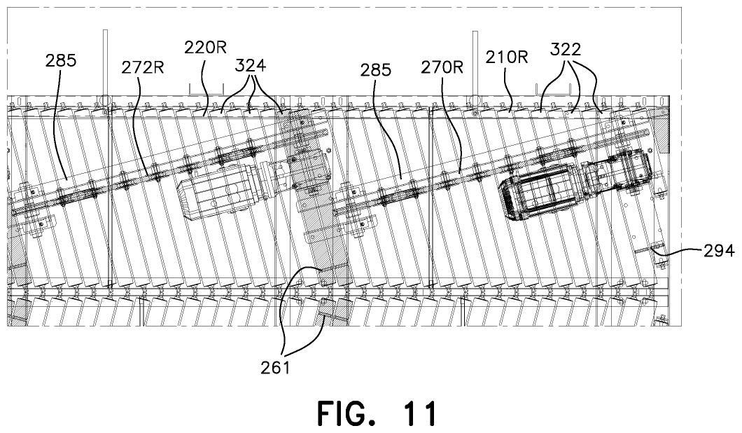

Turning now to the singulating conveyor shown in FIGS. 12-16, the Conveyor B embodiment, it will be apparent to those skilled in the art that most of the components and the operation of the Conveyor B embodiment are the same as previously described in connection with the Conveyor A embodiment illustrated in FIGS. 3-11. Accordingly, the numerals used in FIGS. 12-16 for the Conveyor B embodiment will follow those of the “200” and “300” series, and only those components which are different in the Conveyor B embodiment will be identified by the “500” series.

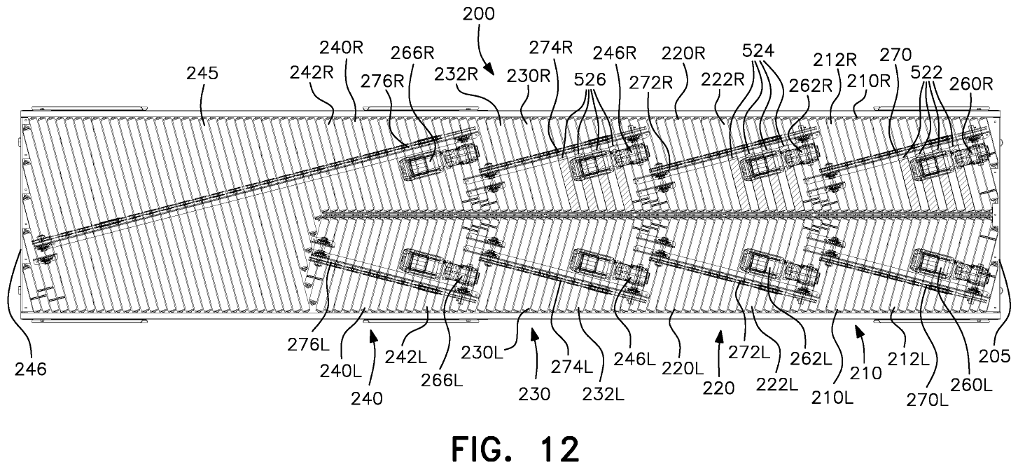

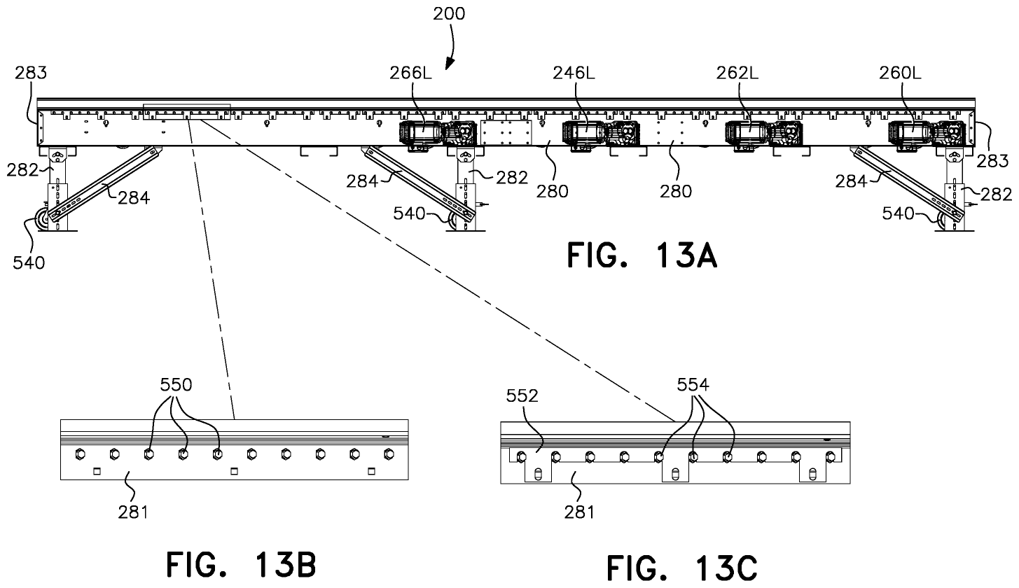

The differences between the Conveyor B embodiment and the Conveyor A are as follows:
(1) the Conveyor B embodiment utilizes frictional coverings on four rollers of each of the first three outer lateral zones, whereas the Conveyor A embodiment utilizes frictional coverings on only three rollers of the first two outer lateral zones;
(2) the Conveyor B embodiment does not include the side panels 286 and vertical support brackets 286 of the Conveyor A embodiment;
(3) the Conveyor B embodiment includes standard swivel caster wheels routinely used in the conveyor industry, which facilitate movement of the Conveyor B embodiment;
(4) All of the V-Belt drive systems of the Conveyor B embodiment are supported on the outside of their respective sheave support angles, rather than between the sheave support angle and the adjacent motor as in the Conveyor A embodiment, in order to make adjustment easier if needed on the sheaves.
(5) the V-Belt drive system for the off-ramp zone of the discharge rollers at the exit end of the Conveyor B embodiment has a slightly different arrangement for the drive sheave, and the engaged V-belt drive traverses a slightly different path; and
(6) the roller axles of the Conveyor B embodiment are supported in vertically elongated hex holes and their vertical movement is limited by specially designed brackets, illustrated specifically in FIGS. 13C and 14.

### Frictional Coverings in the Conveyor B Embodiment

The frictional coverings in the Conveyor B embodiment are shown as shaded rollers in FIG. 12. As can be seen, there are frictional coverings applied to four rollers 522 in zone 210R, four rollers 524 in zone 222R, and four rollers 526 in zone 230R.

### No Side-Panels in the Conveyor B Embodiment

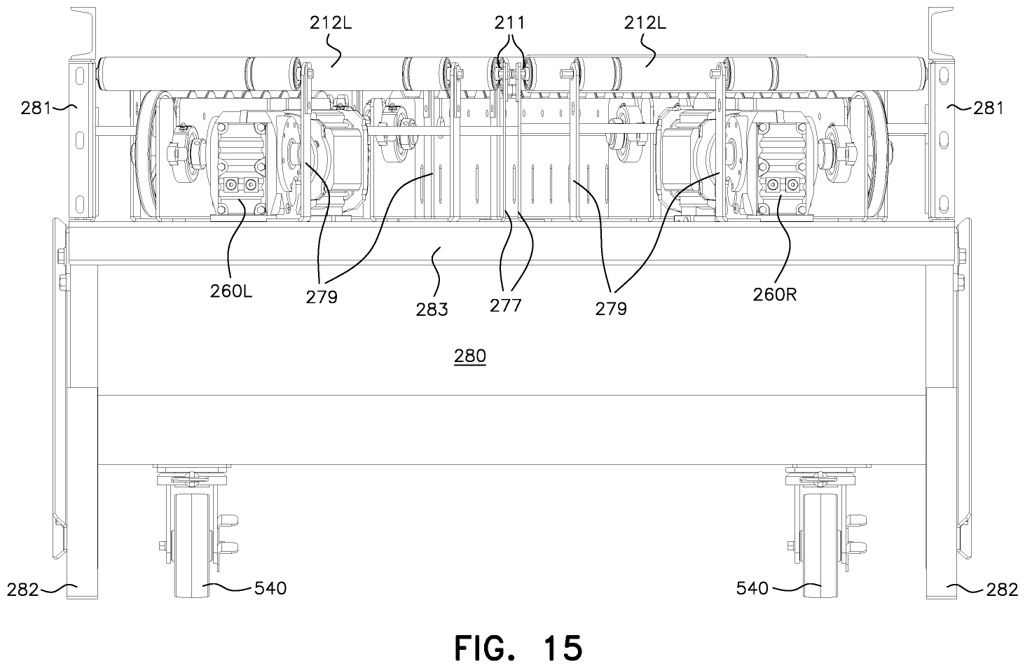

As can be seen from FIGS. 13A and 15, there are no side panels 286 extending upwardly from the side channels 281, or the vertical support brackets 288, in the Conveyor B embodiment.

### Standard Swivel Caster Wheels in the Conveyor B Embodiment

As shown in FIGS. 13A, 14 and 15, the Conveyor B embodiment includes standard swivel caster wheels 540, which allow the Conveyor B embodiment to be easily moved from one location to another.

### V-Belt Drive Systems for the Conveyor B Embodiment

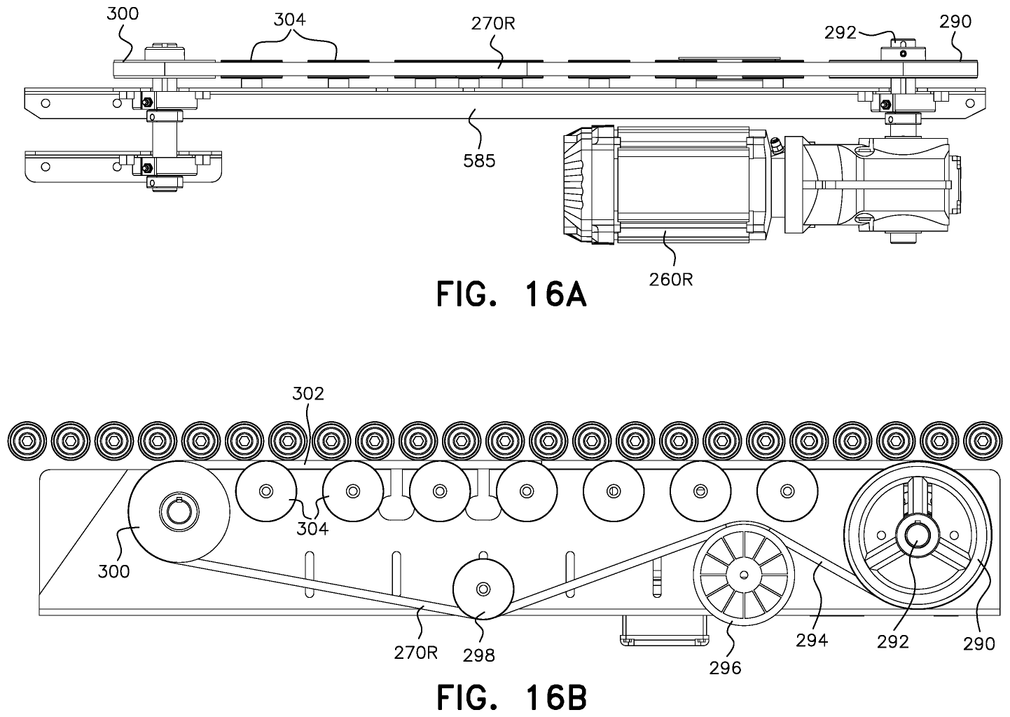

The representative motor 260R and associated V-Belt 270R for the seven zones 210L and 210R, 220L and 220R, 230L and 230R and 240L of the Conveyor B embodiment are shown in FIGS. 16A and 16B. As shown, the V-Belt drive system 270R is mounted on the opposite side (outside) of the sheave support angle 585 from the motor 260R, thus facilitating easier service and repair of the V-Belt drive system 270R. Otherwise, the components of the motors and V-Belt drive systems are the same or equivalent in both the Conveyor A embodiment and the Conveyor B embodiment.

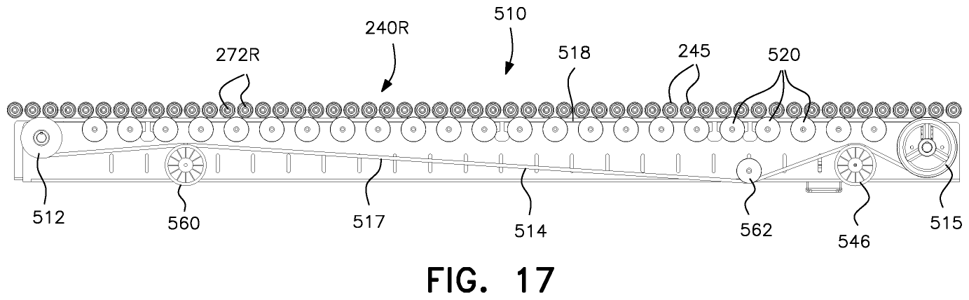

As shown in FIG. 17, the V-Belt drive system for the off-ramp zone 240R of the discharge rollers at the exit end of the Conveyor B embodiment is generally designated by reference numeral 510, and includes V-belt 514. V-belt 514 is driven by draft sheave 512, and its lower extent 517 extends over, under and over three tension spools 560, 562, and 564, respectively, and around horizontally spaced support sheave 515 which is mounted adjacent the exit end 246 of the conveyor 200. The upper horizontal extent 518 of the V-belt 514 between drive sheave 512 and support sheave 515 is also supported by a series of intermediate pulleys 520. The upper surface of the horizontal extent 518 also engages the under surface of the transporting rollers 242R and 245 of zone 240R in the same manner as described and illustrated in connection with the Conveyor A embodiment.

### Vertically Elongated Hex Holes and Specially Designed Brackets for the Conveyor B Embodiment

As shown in FIG. 14, the front end of side channel 281 on the left hand side of the conveyor 200 is shown as supported on the stanchion 282 and angle brace 284. Transporting rollers 212L of the first inner lateral zone 210L are shown and include hex axles 211 with their inner ends supported on center rib 277 and L-brackets 279. The outer ends of hex axles 211 extend above pulleys 304, the extent 302 of V-belt 294 and are then received in the vertically elongated hex holes 550 along the upper edge of the side channel 281. Two of the specially designed hold down brackets 552 are shown, one in position on the side channel 281 and one spaced away to show the position of the hex holes 550. See also FIGS. 13A, B and C. The enlarged vertical characteristic of the hex holes is illustrated in the cut out drawing shown in the lower left-side portion of FIG. 14.

As will be appreciated by those skilled in art, the elongation of the hex holes 550 allows the surface of the transporting rollers in each zone to lay on top of the respective V-belt. The axle shaft 211 of the roller, and the roller itself, is limited vertically in the down direction by the roller being in contact with the V-belt and vertically in the up direction by the notches 554 in the bracket 552.

The following description of roller speeds and roller speed ratios applies equally with respect to conveyor 200 of both the Conveyor A embodiment and the Conveyor B embodiment.

It has been found that the speed of the conveyor 200, and each of the individual eight zones, can be varied depending on the particular application and the parcels to be conveyed and singulated thereby. The zone with the lowest roller speed is zone 210 L and can range from as low as 50 ft. per minute to as high as 150 ft. per minute. Preferably, the speed of the rollers 212 L in zone 210 L is typically set at 131 ft. per minute. Once the speed of the rollers 212 L in zone 210 L is established, there has been success in setting the rollers in the other zones to have speeds according to the following sets of ratios:

| Ratio Set A | Ratio Set B |
|---|---|
| Zone 210 R = 2.18 times zone 210 L | Zone 210 R = 2.37 times zone 210 L |
| Zone 220 R = 1.97 times zone 220 L | Zone 220 R = 2.46 times zone 220 L |
| Zone 230 R = 1.48 times zone 230 L | Zone 230 R = 1.86 times zone 230 L |
| Zone 240 R = 1.26 times zone 240 L | Zone 240 R = 1.08 times zone 240 L |

In addition to the above, the average speed for each of the 4 longitudinal zones change in ratios and should be in accordance with the following:

Ratio Set A
Average of Zones 220 L and R = 1.31 times the average of zones 210 L and R
Average of Zones 230 L and R = 1.28 times the average of zones 220 L and R
Average of Zones 240 L and R = 1.09 times the average of zones 230 L and R
Ratio Set B
Average of Zones 220 L and R = 1.15 times the average of zones 210 L and R
Average of Zones 230 L and R = 1.17 times the average of zones 220 L and R
Average of Zones 240 L and R = 0.83 times the average of zones 230 L and R

In addition to the foregoing preferred speed ratios for the various zones, it is contemplated that the speed ratios can vary +/−twenty percent (20%).

Again, the above description and data for roller speed and ratios is set forth for conveyor 200 and applies equally to the Conveyor A embodiment, and the Conveyor B embodiment.

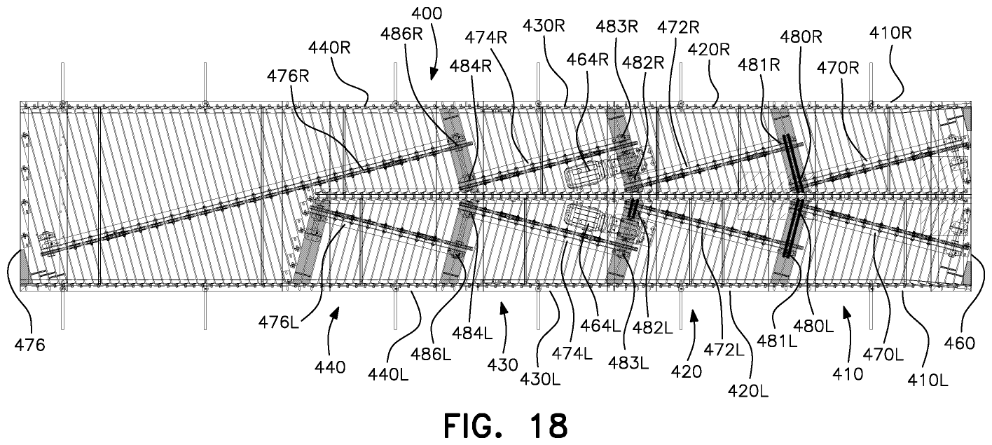

While two preferred embodiments of the present invention have been described in detail in connection with conveyor 200, i.e., the Conveyor A embodiment and the Conveyor B embodiment, it is also possible to achieve the same variable speeds of the eight lateral and longitudinal zones by varying the size of the sheaves which support the V-belts that drive the transporting rollers in each of the eight zones. This alternate preferred embodiment is illustrated in FIG. 18.

As shown in FIG. 18, the Conveyor C embodiment is generally designated by reference numeral 400 and includes four longitudinal zones, generally designated by reference numerals 410, 420, 430 and 440, each of which includes right and left lateral zones 410 L and 410 R, 420 L and 420 R, and 430 L and 430 R, and 440 L and 440 R, respectively, starting at the entry end 460 of the conveyor and terminating at the exit end 446. Singulating conveyor 400, however, includes only two motors, a left-hand motor 464 L which drives four interconnected V-Belt drive systems, including drive system 470 L in zone 410, drive system 472 L in zone 420, drive system 474 L in zone 430 and drive system 476 L in zone 440, as shown by interconnecting shafts. Conveyor 400 additionally includes a right hand motor 464 R which drives four interconnected V-Belt drive systems, including drive system 470 R in zone 410, drive system 472 R in zone 420, drive system 474 R in zone 430 and drive system and 476 R in zone 440, as shown by interconnecting shafts. The relevant sheaves are sheaves 480 L and 480 R in zone 410, sheaves 481 L and 481 R and 482 L and 482 R in zone 420, sheaves 483 L and 483 R and 484 L and 484 R in zone 430, and sheaves 486 L and 486 R in zone 440.

In order to accomplish the speed ratios outlined above for conveyors 200, it is believed that the sheave diameters for conveyor 400 should be arranged in the following ratios:

| Ratio Set A | Ratio Set B |
|---|---|
| Sheave 481 L = 1.40 times sheave 480 L | Sheave 481 L = 1.12 times sheave 480 L |
| Sheave 483 L = 1.53 times sheave 482 L | Sheave 483 L = 1.42 times sheave 482 L |
| Sheave 486 L = 1.20 times sheave 484 L | Sheave 486 L = 1.14 times sheave 484 L |
| Sheave 481 R = 1.27 times sheave 480 R | Sheave 481 R = 1.16 times sheave 480 R |
| Sheave 483 R = 1.15 times sheave 482 R | Sheave 483 R = 1.07 times sheave 482 R |
| Sheave 486 R = 1.02 times sheave 484 R | Sheave 486 R = 0.66 times sheave 484 R |

In addition to the foregoing preferred sheave diameter ratios for the various V-Belt drive systems, it is contemplated that the diameter ratios can vary +/−ten percent (10%).

The first preferred embodiments of the present invention have been described in detail in connection with conveyors 200 and 400 having the parcels exit on the left hand side of the conveyor. If it is desired to have the parcels exit to the right hand side of the conveyors, the speed ratios mentioned before should be swapped between L and R.

The method for operating a singulating conveyor in accordance with the first preferred embodiments of the present invention should be evident to those skilled in the art based upon the foregoing descriptions and related drawing figures. For example, the Conveyor B embodiment illustrated in FIGS. 12-17 is operated with a selected speed of the transporting rollers in each longitudinal zone increasing sequentially from the entrance end of the conveyor to the exit end of the conveyor, while at the same time simultaneously operating the outer lateral zones at a selected higher speed than the transporting rollers in the corresponding and adjacent inner lateral zones, except perhaps the outer lateral zone that includes the discharge rollers 245. The outer lateral zone which includes discharge rollers 245 is operated at an increased or decreased speed to achieve the selected exit speed of the parcels from the conveyor. The Conveyor A embodiment is operated in a similar fashion as described with respect to the Conveyor B embodiment, and the Conveyor C embodiment is also operated in a similar fashion.

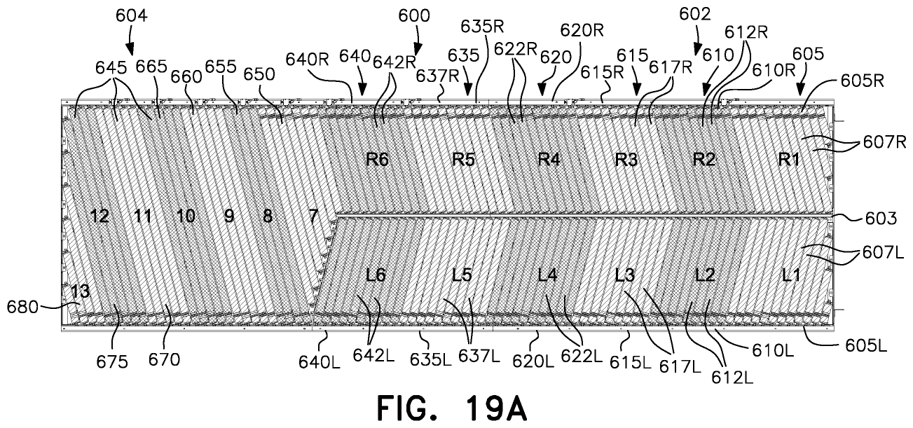

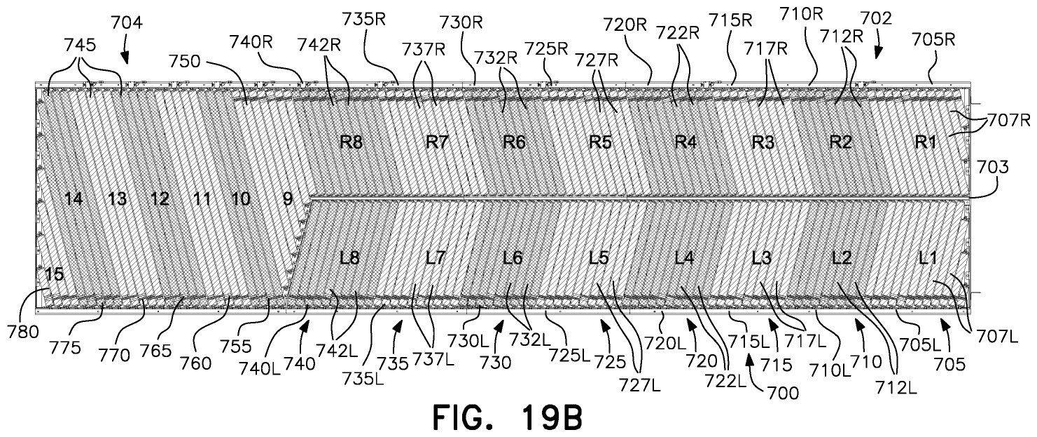

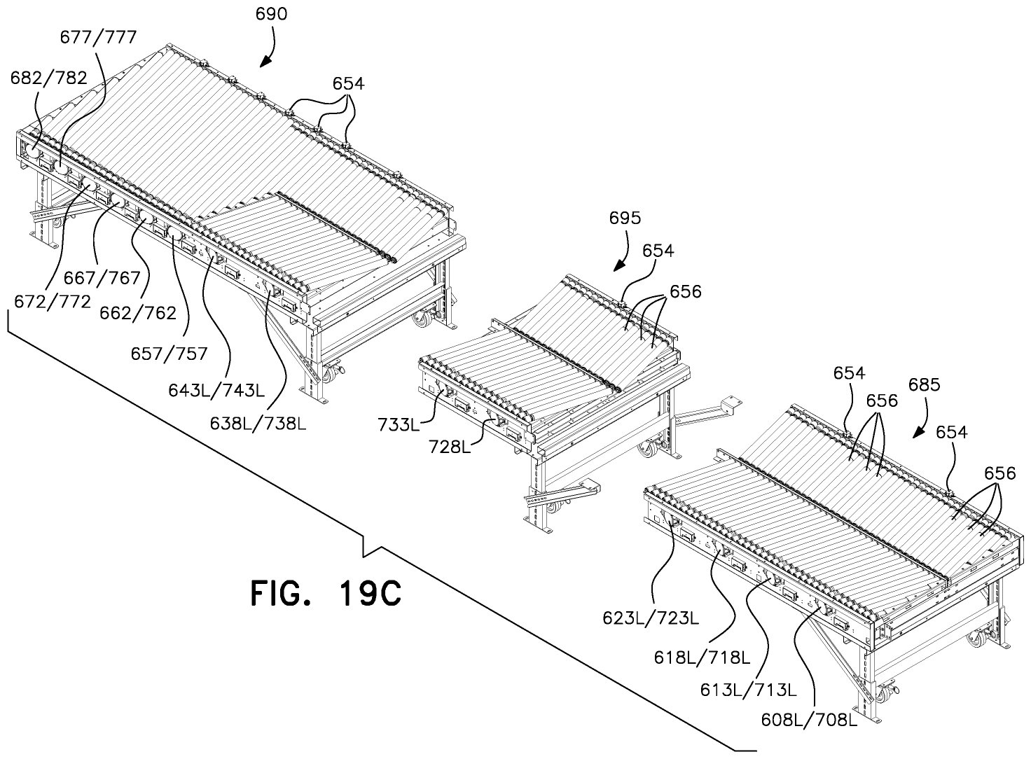

Turning now to the singulating conveyors of the second preferred embodiments, the Conveyor D embodiment and the Conveyor E embodiment, as shown in FIGS. 19A-28, inclusive, it will be apparent to those skilled in the art that many of the components and some of the operation of the Conveyor D embodiment and the Conveyor E embodiment are the same as previously described in connection with the Conveyor A embodiment illustrated in FIGS. 3-11 and the Conveyor B embodiment illustrated in FIGS. 12-16. However, in view of the various differences, different numerical series, the “600” series for the Conveyor D embodiment and the “700” series for the Conveyor E embodiment, will be used hereinafter. Where the components of the Conveyor D embodiment are the same as those of the Conveyor E embodiment, the second and third digits in each series will be the same.

FIG. 19A shows a top plan view of the Conveyor D embodiment, generally designated by reference numeral 600. As shown, the forward or herringbone portion, generally designated by reference numeral 602, of the conveyor is preferably divided into six (6) longitudinal zones of rollers, generally designated by reference numerals 605, 610, 615, 620, 635, and 640, which are driven at increasing speeds from the first zone 605 at the entrance end 603 of the conveyor toward the sixth zone 640 at the end of the front portion 602 of the conveyor.

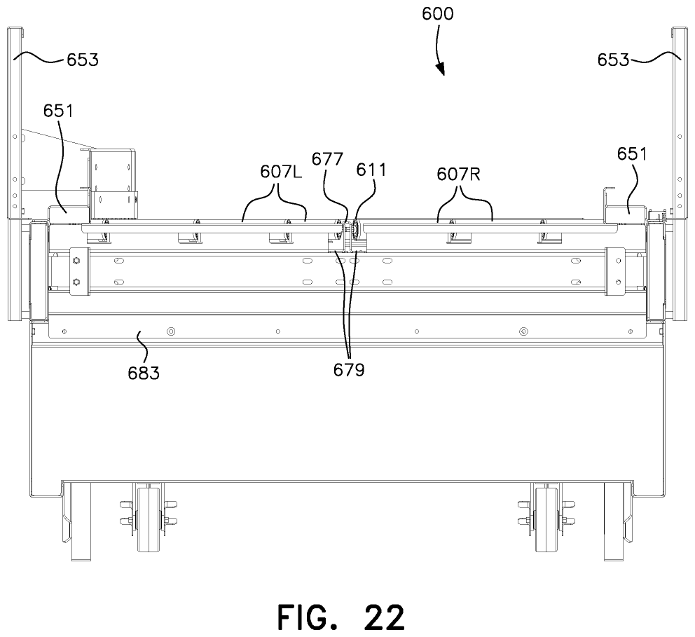

Each of the longitudinal zones 605, 610, 615, 620, 635, and 640, includes a pair of side-by-side lateral zones designated left (L) and right (R), thus forming six (6) outside lateral zones 605R, 610R, 615R, 620R, 635R, and 640R, designated zones R1-R6, inclusive, on FIG. 19A, and six (6) inside lateral zones 605L, 610L, 615L, 620L, 635L, and 640L, designated zones L1-L-6, inclusive, on FIG. 19A. Each lateral zone of each longitudinal zone in the herringbone portion 602 of the conveyor, twelve (12) zones in total, includes a series of transporting rollers 607L and 607R, 612L and 612R, 617L and 617R, 622L and 622R, 637L and 637R, and 642L and 642R. The rollers in each complementary lateral zone in the herringbone portion 602 of the conveyor 600 are in parallel alignment, but skewed at an angle with the outer end of the rollers being forward compared to the inner end of the rollers. The skewing causes the transported parcels to be driven toward the center line 603 of the conveyor. In a preferred configuration, the parallel rollers in each lateral zone are skewed forwardly at an angle of 75.5% from the center line of the conveyor, but the skewed angle can vary as much as plus or minus five percent (5%). As shown in FIGS. 22, 24B and 26, the rollers have conventional supporting hexagonal (hex) axles 611 which are located in corresponding main hex holes 613 in inside channels 681 and center ribs 677 of the framework 683, except the shortened rollers at various locations along the conveyor 600, which have one axle supported by L-brackets 679 similar to the Conveyor A embodiment.

The discharge or skew portion, generally designated by reference numeral 604 of the conveyor 600 includes discharge rollers 645, preferably divided into seven (7) separate longitudinal zones 650, 655, 660, 665, 670, 675, and 680, designated zones 7-13, inclusive, on FIG. 19A. The angling of the rollers 645 at the skew portion 604 continues at the same angle as the outer rollers 607R, 612R, 617R, 622R, 637R, and 642R, and this angling of the rollers at the exit end moves the parcels from the center or center line 603 of the conveyor to the left side. If desired to have the parcels exit to the right hand side of the conveyor 600, the discharge rollers 645 should be aligned with the rollers of the L side of the conveyor, rather than the R side.

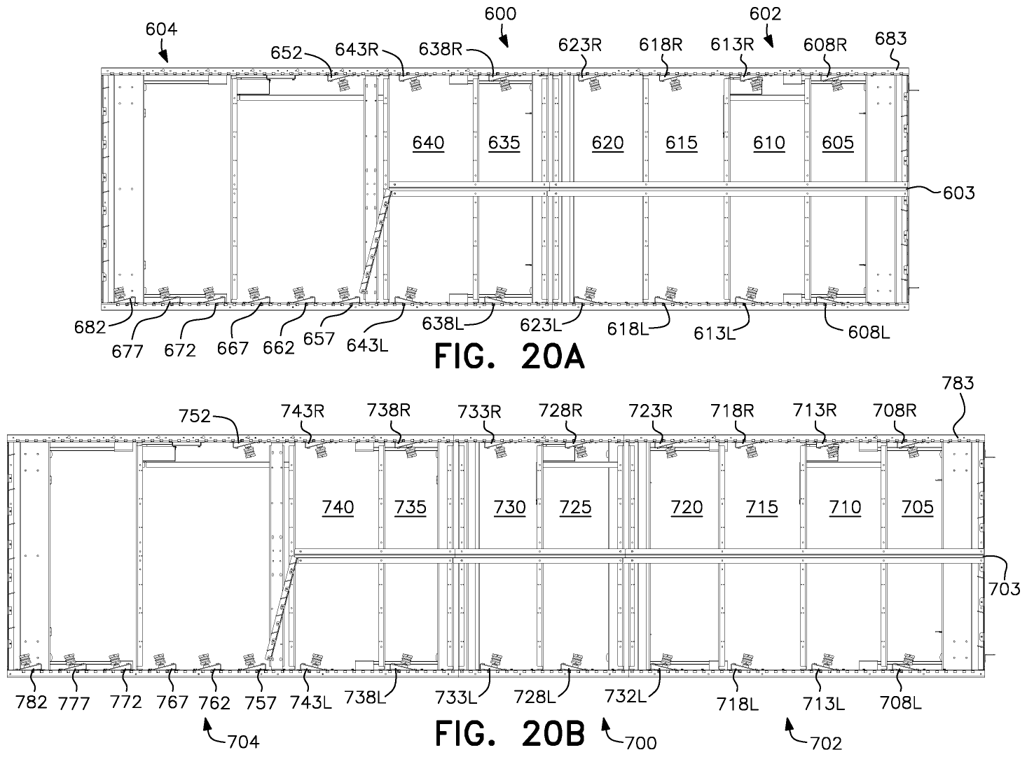

Each of the six (6) lateral zones L and R in the herringbone portion 602 of the Conveyor D embodiment is preferably operated by utilizing a separate motor for each lateral zone, motors 608R, 613R, 618R, 623R, 638R, and 643R on the right hand side of the conveyor and motors 608L, 613L, 618L, 623L, 638L, and 643L, on the left hand side of the conveyor, twelve (12) motors in all. See FIG. 20A. Each of the seven (7) separate additional longitudinal zones 650, 655, 660, 665, 670, 675, and 680 of the discharge portion 604 of the conveyor is also preferably operated by utilizing a separate motor 652, 657, 662, 667, 672, 677, and 682 for each separate longitudinal zone, seven (7) motors in all. Thus, there are nineteen (19) motors in all for the Conveyor D embodiment, and each motor can be controlled by Its own separate variable speed controller, if desired by the user. Hence, each separate group of rollers or zones in the forward portion of the Conveyor D embodiment, twelve (12) in all, has speeds which vary both laterally and longitudinally across the conveyor. Each of the seven (7) separate groups or zones of the discharge rollers 645 also have speeds which can vary longitudinally along the conveyor.

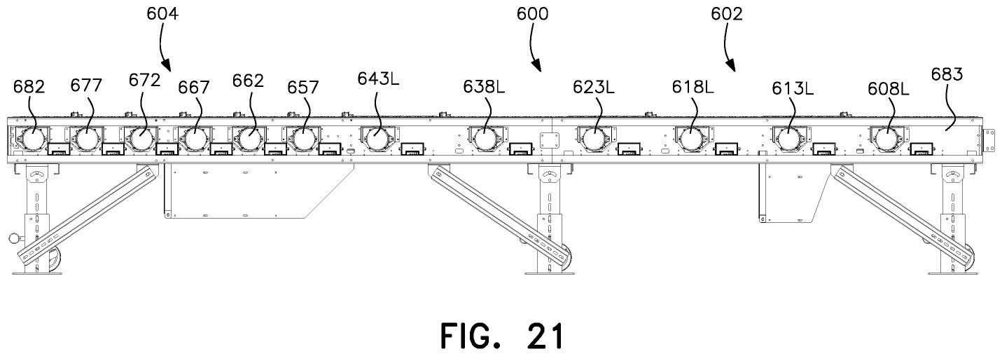

As shown FIGS. 20A and 21, all of the motors 608L and 608R, 613L and 613R, 618L and 618R, 623L and 623R, 638L and 638R, and 643L and 643R of the forward portion 602 and all of the motors 652, 657, 662, 667, 672, 677, and 682 of the discharge portion 604 are mounted underneath the rollers 607L and 607R, 612L and 612R, 617L and 617R, 622L and 622R, 637L and 637R, 642L and 642R, and 645L and 645R of the respective zones and supported from the horizontal framework 683 adjacent the outer edge on each side of the framework and positioned at an angle similar to the skewed angle of the rollers.

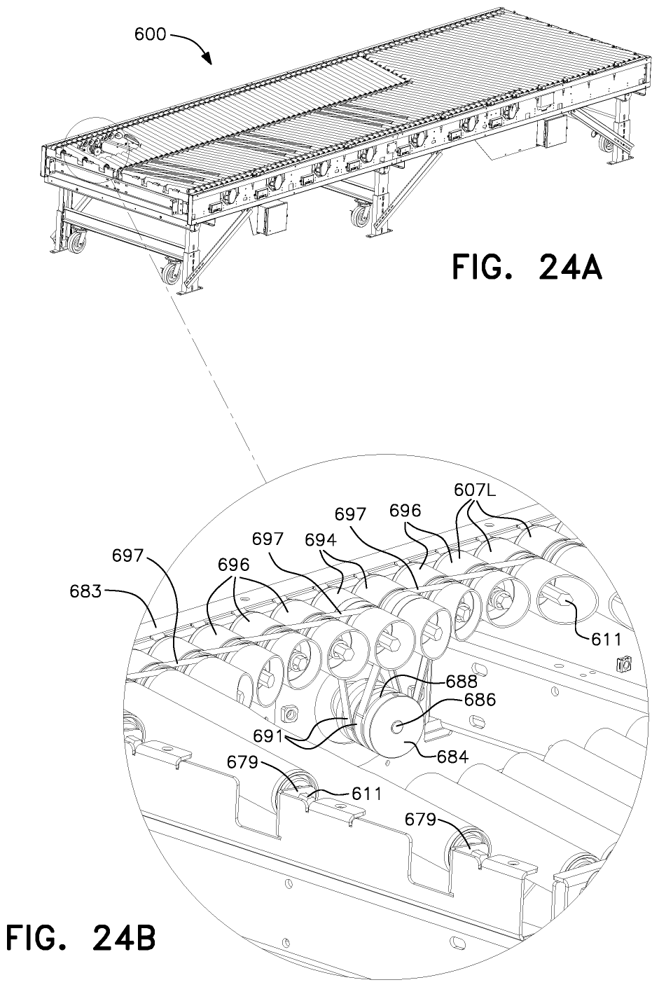

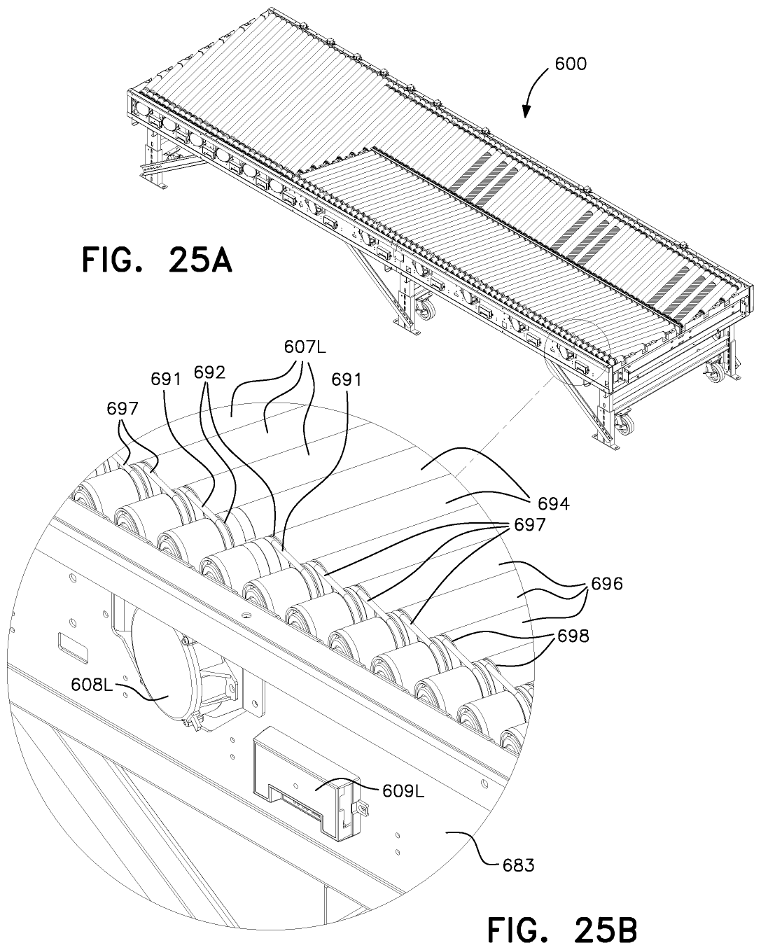

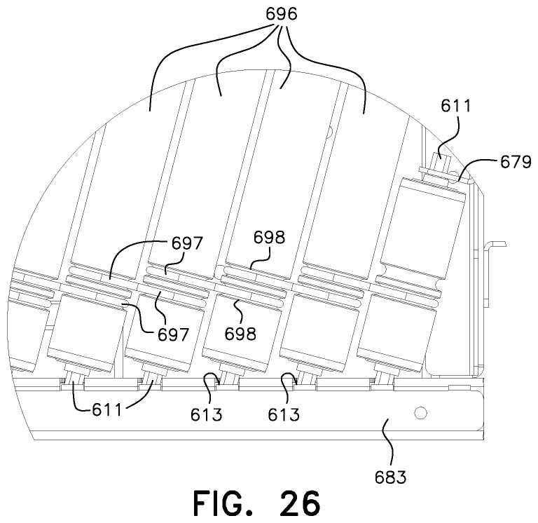

As shown in FIGS. 24B and 25B, a drive sheave 684 is mounted on each motor shaft 686 and includes two side-by-side grooves 688, each of which engages a complementary drive band 691. Each drive band 691 is tensioned around complementary grooves 692 formed near the outer end of adjacent drive rollers 694 which are shown as part of rollers 607L. As such, each motor can individually drive its associated adjacent drive rollers 694 at a specific selected drive speed. The remaining rollers 696 of each conveyor group or zone, the driven rollers, are interconnected to the drive rollers 694 and to each other by a series of power roller belts 697, which engage complementary grooves 698 on the outer ends of adjacent rollers 696. See also FIG. 26. One preferred drive band is the Fenner Eagle XLD Band commercially available from Fenner Drives, Inc. of Lititz, PA, and one preferred power roller belt is the Dura-Belt Long Life 0.210″ HT RED belt 85A, commercially available from Dura-Belt, Inc. of Hilliard, OH.

The drive system described in the two preceding paragraphs is the same for driving the discharge rollers 645 in each of the seven (7) separate discharge zones 650, 655, 660, 665, 670, 675, and 680 by their respective separate motors 652, 657, 662, 667, 672, 677, and 682. As shown in FIG. 25B, the motor 608L is mounted on a side frame of the framework 683, along with its related controller 609L and ethernet I/P module (not shown). A preferred motor is UniDrive DC Motor 300990 (120 W), used with UniDrive Zonelogix Controller 301122 and UniDrive Zonelogix Gateway Ethernet I/P Module. The aforesaid motors and related equipment are commercially available from Automation Controls Group of Glendale, WI.

Hence, the rollers 607L and 607R, 612L and 612R, 617L and 617R, 622L and 622R, 637L and 637R, and 642L and 642R of the forward portion 602 of the conveyor and the rollers 645 of the discharge portion 604 of the conveyor can be individually operated at selected speeds.

As shown in FIGS. 22, 23A, 23B, 27A, 27B, and 28, the outer ends of the transporting rollers in both the forward or singulating portion 602 and the discharge portion 604 of the conveyor 600, are covered by band guards 651 on both the right hand and left hand sides of the conveyor 600. The band guards 651 serve to protect the drive system for the transporting rollers, including the portion of the motors which extend inwardly and their related drives sheaves 684, drive bands 691 and power roller belts 697. Further, as shown, the conveyor 600 can include optional side panels 653.

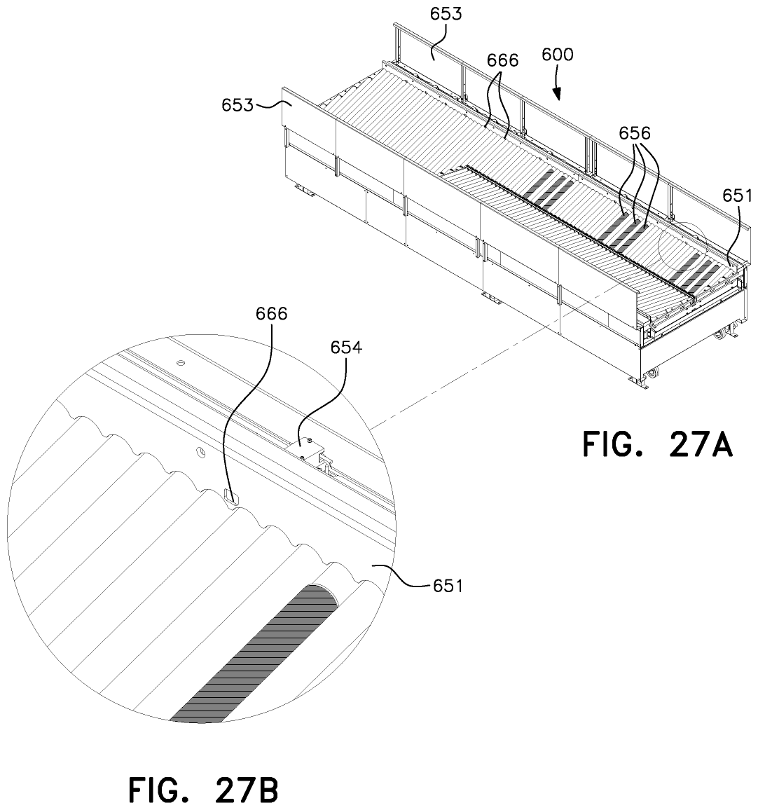

FIGS. 27A and 27B show optional photoeyes 654 which, as shown, are installed inside the band guard 651 along the full length on the right side of the conveyor 600, project inwardly and look through holes 666 towards the center of the conveyor 600. As shown in FIG. 27A, there are nine photoeyes in the Conveyor D embodiment (the photoeyes 654 are hidden, but the look through holes 666 are shown). In FIG. 19C, described hereinafter, there are two photoeyes 654 in the first modular conveyor section and seven photoeyes 654 in the second modular conveyor section, thus making for the nine photoeyes in the Conveyor D embodiment. There is one photoeye 654 in the third modular conveyor section, thus making ten photoeyes in the Conveyor E embodiment.

The photoeyes 654 are installed to detect when there is a large number of parcels moving in a zone in small intervals of time, so that the speed of the transporting rollers can be adjusted, as necessary. The optional photoeyes 654 are preferably installed along the outer lateral zones of the conveyor 600, but can be installed on the inner lateral zones if necessary.

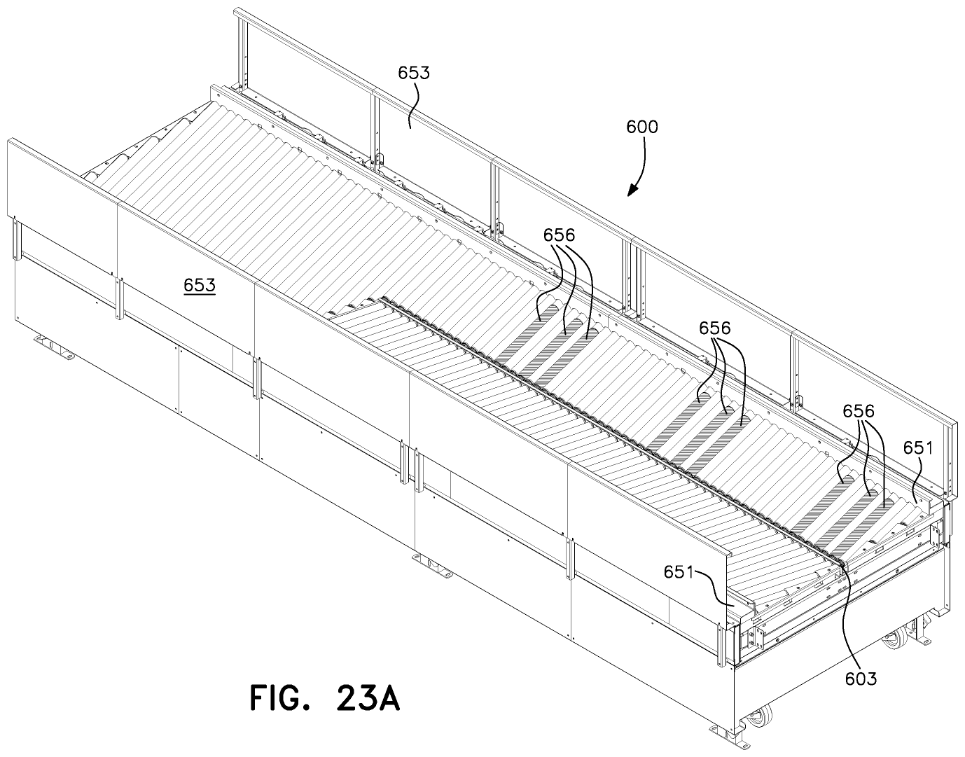

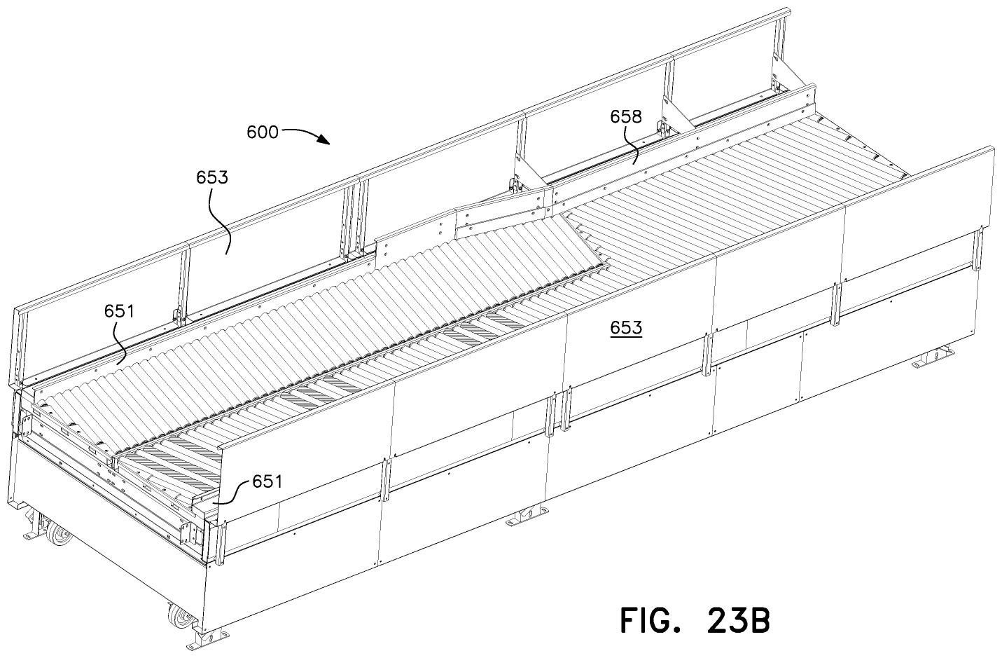

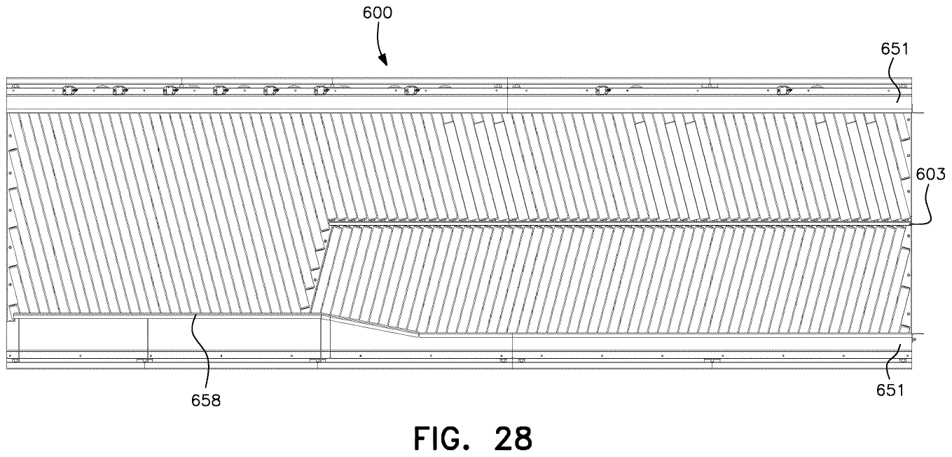

As shown in various drawings including FIGS. 19C, 23A, 27A and 28, multiple rollers in the outer lateral zones of the conveyor 600 can be fitted with frictional coverings 656, which are the same as described previously in connection with the first preferred embodiments. In addition, FIGS. 23B and 28 show an optional parcel guide 658 which extends longitudinally adjacent the ends of the transporting rollers of the last inside lateral zone 640L of the herringbone portion and all of the longitudinal zones of the skew portion 604 of the conveyor, installed along the discharge side (the L side as shown).

Turning now to the Conveyor E embodiment, as shown in top plan view in FIG. 19B, the conveyor is generally designated by reference numeral 700. The forward or herringbone portion, generally designated by reference numeral 702, of the Conveyor E embodiment is preferably divided into eight (8) longitudinal zones of rollers, generally designated by reference numerals 705, 710, 715, 720, 725, 730, 735 and 740, which are driven at increasing speeds from the first zone 705 at the entrance end 703 of the conveyor towards the eighth zone 740 at the end of the front portion 702 of the conveyor.

Each of the longitudinal zones 705, 710, 715, 720, 725, 730, 735, and 740 includes a pair of side-by-side lateral zones designated left (L) and (R), thus forming eight (8) outside lateral zones 705R, 710R, 715R, 720R, 725R, 730R, 735R, and 740R, designated zones R1-R8, inclusive, on FIG. 19B, and eight (8) inside lateral zones 705L, 710L, 715L, 720L, 725L, 730L, 735L, and 740L, designated zones L1-L8, inclusive, on FIG. 19B. Each lateral zone of each longitudinal zone in the herringbone portion 702 of the Conveyor E embodiment, sixteen (16) zones in total, includes a series of transporting rollers 707L and 707R, 712L and 712R, 717L and 717R, 722L and 722R, 727L and 727R, 732L and 732R, 737L and 737R, and 742L and 742R.

As with the Conveyor D embodiment, the rollers in each complementary lateral zone in the herringbone portion 702 of the conveyor 700 in the Conveyor E embodiment are in parallel alignment, but skewed at an angle with the outer end of the rollers being forward compared to the inner end of the rollers. In a preferred configuration, the parallel rollers in each lateral zone are skewed forwardly also at an angle of 75.5% from the center line 703 of the conveyor, but the skewed angle can vary as much as plus or minus five percent (5%).

The rollers of the Conveyor E embodiment have the same conventional supporting hexagonal (hex) axles as previously described in connection with the Conveyor D embodiment and are located in corresponding main hex holes in inside channels and center ribs, except the shortened rollers have their inside axle supported by L brackets, all as previously described in connection with the Conveyor A embodiment and the Conveyor D embodiment.

The discharge or skew portion 704 of the conveyor 700 includes discharge rollers 745, again preferably divided into seven (7) separate longitudinal zones 750, 755, 760, 765, 770, 775, and 780, designated as zones 9-15, inclusive, on FIG. 19B. The discharge portion 704 is the same as discharge portion 604, previously described in connection with the Conveyor D embodiment.

As previously described with respect to the Conveyor D embodiment, each of the eight (8) lateral zones L and R in the forward portion 702 of the Conveyor E embodiment is preferably operated by utilizing a separate motor 708L and 708R, 713L and 713R, 718L and 718R, 723L and 723R, 728L and 728R, 733L and 733R, 738L and 738R, and 743L and 743R, for each lateral zone, sixteen (16) motors in all, as illustrated in FIG. 20B. The skew portion 704 of the conveyor 700 is the same as the skew portion 604 of conveyor 600. As such, each of the seven (7) separate additional longitudinal zones of the skew portion 704 of the conveyor 700 is also preferably operated by utilizing a separate motor 752, 757, 762, 767, 772, 777, and 782 for each separate longitudinal zone, seven (7) motors in all, the same as previously described in connection with the Conveyor D embodiment, as also illustrated in FIG. 20B. Thus, there are twenty-three (23) motors in all for the Conveyor E embodiment, and each motor can be controlled by its own separate variable speed controller, if desired by the user. Hence, each separate group of rollers or zones in the herringbone portion of the Conveyor E embodiment, sixteen (16) in all, has a speed which can vary both laterally and longitudinally across the conveyor. Each of the seven (7) separate groups or zones of the discharge rollers 745 also has speeds which can vary longitudinally along the conveyor.

The drive system between each of the twenty-three (23) motors of the Conveyor E embodiment and the respective rollers of each of the sixteen (16) lateral zones in the forward portion 702 and the seven (7) longitudinal zones of the discharge portion 704 is the same as previously described in connection with the Conveyor D embodiment and illustrated in FIGS. 24B and 25B.

As will be evident to those skilled in the art, the features previously described with respect to conveyor 600 of the Conveyor D embodiment relating to the band guards 651 and the optional side panels 653, photoeyes 654, and parcel guide 658, apply equally to conveyor 700 of the Conveyor E embodiment.

A desirable feature of the second preferred embodiments of the present invention is a simplification of the manufacturing process, which provides for better inventory control and operational flexibility. By using a first modular conveyor section as part of the herringbone portions 602 and 702 of conveyors 600 and 700 and a second modular conveyor section having the same skew portions 604 and 704, the Conveyor D embodiment can be expanded into the Conveyor E embodiment by simply combining a third modular conveyor section between the first two modular conveyor sections. This relationship is illustrated in FIG. 19C.

As shown in FIG. 19C, the first modular conveyor section, generally designated by reference numeral 685, includes the first four (4) longitudinal zones of the herringbone portions 602 and 702 of conveyors 600 and 700, identified as zones 605, 610, 615, and 620 in the Conveyor D embodiment, and zones 705, 710, 715 and 720 in the Conveyor E embodiment. The second modular conveyor section, generally designated by reference numeral 690, can be the same for both the Conveyor D embodiment and the Conveyor E embodiment and includes the last two longitudinal zones of the herringbone portion of conveyors 600 and 700, i.e. zones 635 and 640 for the Conveyor D embodiment and zones 735 and 740 for the Conveyor E embodiment, and the skew portion for the conveyors, i.e. skew portion 646 of the Conveyor D embodiment and skew portion 746 of the Conveyor E embodiment. In order to expand the Conveyor D embodiment into the Conveyor E embodiment, the third modular conveyor section 695 is added between sections 685 and 690, as shown in FIG. 19C. The third modular conveyor section 695 consists of zones 625 and 630 of the Conveyor E embodiment, as previously described. The zones are not numerically identified on FIG. 19C, only the motors on the left hand side.

As will be readily understood by those skilled in the art, the above described modular manufacturing process can be applied to a variety of sizes for singulating conveyors. More specifically, the first modular conveyor section can consist of two or more longitudinal zones for the entry end of the conveyor. The second modular conveyor section can consist of one or more of the last longitudinal zones of the herringbone portion of the conveyor together with the skew portion of the conveyor. The third modular conveyor section can then include one or more longitudinal zones of the herringbone portion. The make-up of the three modular zones can obviously be varied depending upon the size and variety of singulating conveyors to be manufactured.

As has been previously described, each of the inner and outer lateral zones of the herringbone portion 602 of conveyor 600 and each of the seven longitudinal zones of the skew portion 604 is operated by a separate motor, and therefore the speed of the rollers can be established as desired by the user. As with the first preferred embodiments, it has been found that the speed of the rollers in the outer lateral zones of the herringbone portion should be greater than the speed of the rollers in their complementary inner lateral zones, and the speed in each progressive longitudinal zone should increase sequentially from Zone 1 to Zone 6. On the other hand, it has been found preferable to vary the speed sequentially in the zones of the skew portion for better singulation.

The method for operating a singulating conveyor in accordance with the second preferred embodiments of the present invention should also be evident to those skilled in the art based upon the forgoing descriptions and related drawing figures. Below is a chart showing representative speeds for each zone of the Conveyor D embodiment.

| | | | | | | Avg |
|---|---|---|---|---|---|---|
| | Zone | R | L | Avg | Ratio | Ratio |
| 605 | 1 | 260 | 118 | 189 | 2.20 | |
| 610 | 2 | 260 | 118 | 189 | 2.20 | 1.00 |
| 615 | 3 | 312 | 180 | 246 | 1.73 | 1.30 |
| 620 | 4 | 312 | 180 | 246 | 1.73 | 1.00 |
| 635 | 5 | 410 | 310 | 360 | 1.32 | 1.46 |
| 640 | 6 | 410 | 310 | 360 | 1.32 | 1.00 |

| | | | | |
|---|---|---|---|---|
| 650 | 7 | 431 | 431 | 1.20 |
| 655 | 8 | 431 | 431 | 1.00 |
| 660 | 9 | 440 | 440 | 1.02 |
| 665 | 10 | 440 | 440 | 1.00 |
| 670 | 11 | 360 | 360 | 0.82 |
| 675 | 12 | 268 | 268 | 0.74 |
| 680 | 13 | 445 | 445 | 1.66 |

The above numbers in the left hand column correspond to the numbers appearing in the drawings for each of the longitudinal Zones 1-13, respectively, of the Conveyor D embodiment. The R and L columns represent speeds in the outer lateral zone (R) and inner lateral zone (L) in the herringbone portion 602 of the conveyor 600, and the numbers in the middle column for Zones 7-13 are the representative speeds for the zones in the skew portion. The information provided in the Avg, Ratio and Avg Ratio columns are simple calculations based upon the speeds provided.

As can be seen from the above chart, Zones 1-10 of the conveyor 600 preferably operate at speeds as previously described in connection with the first preferred embodiments and sequentially increase, while having a higher speed in the outer lateral zones compared to their complementary inner lateral zones in order to cause a swirling action of the parcels being transported. Zones 11 and 12 slow down to stack parcels together end to end, and Zone 13 then speeds up to put a gap between parcels for sorting at the exit end of the conveyor.

It should be appreciated that the speeds provided in the above chart are representative and can be determined by the user as best suits operation and use of the conveyor 600. However, it is considered preferable that the speed ratio should not vary more than +/−twenty percent (20%) from the speed ratios listed in the above chart.

Turning now to the Conveyor E embodiment, the chart below shows representative speeds for each zone of the conveyor 700.

| | | | | | | Avg |
|---|---|---|---|---|---|---|
| | Zone | R | L | Avg | Ratio | Ratio |
| 705 | 1 | 240 | 125 | 182.5 | 1.92 | |
| 710 | 2 | 240 | 125 | 182.5 | 1.92 | 1.00 |
| 715 | 3 | 240 | 125 | 182.5 | 1.92 | 1.00 |
| 720 | 4 | 240 | 125 | 182.5 | 1.92 | 1.00 |
| 725 | 5 | 300 | 175 | 237.5 | 1.71 | 1.30 |
| 730 | 6 | 300 | 175 | 237.5 | 1.71 | 1.00 |
| 735 | 7 | 240 | 240 | 240 | 1.00 | 1.01 |
| 740 | 8 | 240 | 240 | 240 | 1.00 | 1.00 |

| | | | | |
|---|---|---|---|---|
| 750 | 9 | 220 | 220 | 0.92 |
| 755 | 10 | 450 | 450 | 2.05 |
| 760 | 11 | 450 | 450 | 1.00 |
| 765 | 12 | 450 | 450 | 1.00 |
| 770 | 13 | 350 | 350 | 0.78 |
| 775 | 14 | 140 | 140 | 0.40 |
| 780 | 15 | 450 | 450 | 3.21 |

Again, the above numbers in the left hand column correspond to the numbers appearing in the drawings for each of the longitudinal Zones 1-15, respectively, of the Conveyor E embodiment. The R and L columns represent speeds in the outer lateral zone (R) and the inner lateral zone (L) in the herringbone portion 702, and the numbers in the middle column for Zones 9-15 are representative speeds for the zones in the skew portion. The information provided in the Avg, Ratio and Avg Ratio columns again are simple calculations based upon the speeds provided.

As can be seen from the above chart, the speeds in Zone 1-4 remain constant, although the speed of the outer lateral zones are greater than the speeds of their complementary inner lateral zones in order to create the desired swirling action. The speed increases in Zones 5 and 6, and thereafter decreases in Zones 7 and 8 in the outer lateral zones, while the speed in the inner lateral zones increases to be equal to that in the outer lateral zones. This arrangement of the speed in Zones 7 and 8 allows the parcels to align in a single row in the center of the conveyor.

As the parcels move into the skew portion 704 of conveyor 700, the speed in Zone 9 is decreased from the speed in Zones 7 and 8, which allows the parcels to stack together end-to-end. The substantially increased but equal speed in Zones 10-12, pulls a gap between parcels while they are stacked in line against the diverter 658. Zones 13 and 14 slow down the parcel speed to stack the parcels together end-to-end, and Zone 15 then speeds up to pull a gap between parcels before the parcels exit the conveyor.

Again, it should be appreciated that the speeds provided in the above chart are representative and can be determined by the user as best suits operations and use of the conveyor 700. However, it is considered preferable that the speed ratio should not vary more than +/twenty percent (20%) from the speed ratios listed in the above chart.

The foregoing is considered as illustrative of the principles of the invention. Further, numerous modifications and changes will readily occur to those skilled in the art. As such, it is not desired to limit the invention to the exact construction and operation shown and described; all suitable modifications and equivalents may be resorted to falling within the scope of the invention.

What is claimed is:

1. A singulating conveyor comprising:
transporting rollers extending from an entry end of the conveyor to an exit end of the conveyor and divided into a herringbone portion followed by a skew portion, each of which portions has a plurality of longitudinal zones;
the transporting rollers of each longitudinal zone in the herringbone portion is divided at a longitudinal center line of the conveyor into a pair of complementary outside and inside lateral zones, said transporting rollers of each lateral zone skewed at an angle with an outer end of the rollers being forward compared to an inner end of the rollers so that said longitudinal zones and said lateral zones are arranged in a herringbone pattern; and
the transporting rollers of each of said longitudinal zones and each of said lateral zones operate at a selected speed to singulate and transport a random flow of parcels at said entry end of the conveyor to said skew portion for transport of the parcels to the exit end of the conveyor.

2. The singulating conveyor in accordance with claim 1, wherein the plurality of longitudinal zones of the skew portion of the conveyor are also operated at selected speeds to better singulate the parcels exiting the conveyor.

3. The singulating conveyor in accordance with claim 1, wherein the transporting rollers in the herringbone portion are divided into six or eight longitudinal zones, thus a total of twelve or sixteen lateral zones, respectively.

4. The singulating conveyor in accordance with claim 2, wherein the transporting rollers in the skew portion are divided into seven longitudinal zones.

5. The singulating conveyor in accordance with claim 4, wherein a first four of the six longitudinal zones in the herringbone portion form a first modular conveyor section and the last two longitudinal zones of the herringbone portion together with all of the longitudinal zones of the skew portion form a second modular conveyor section, such that said singulating conveyor having six longitudinal zones in the herringbone portion can be expanded to a conveyor having eight longitudinal zones in the herringbone portion by adding a middle modular conveyor section having two longitudinal zones.

6. The singulating conveyor in accordance with claim 3, wherein a separate motor and drive system operates the transporting rollers of each lateral zone in each of the said plurality of longitudinal zones, making a total of twelve or sixteen separate motors and drive systems for said herringbone portion.

7. The singulating conveyor in accordance with claim 4, wherein a separate motor and drive system operates the transporting rollers of each longitudinal zone, making a total of seven separate motors and drive systems for said skew portion.

8. The singulating conveyor in accordance with claim 2, wherein a separate motor and drive system operates the transporting rollers of each lateral zone in each of said plurality of longitudinal zones in the herringbone portion and each of the longitudinal zones of the skew portion.

9. The singulating conveyor in accordance with claim 8, wherein the transporting rollers in the herringbone portion are divided into six or eight longitudinal zones and the transporting rollers in the skew portion are divided into seven longitudinal zones, thus a total of thirteen or fifteen longitudinal zones and nineteen or twenty-three separate motor and drive systems, respectively.

10. The singulating conveyor in accordance with claim 1, wherein at least some of the transporting rollers in the outside lateral zones of a plurality of the longitudinal zones have a higher coefficient of friction than the transporting rollers of their corresponding and adjacent inside lateral zones.

11. The singulating conveyor in accordance with claim 2, wherein the transporting rollers of the skew portion are a continuation of the transporting rollers of the last outside lateral zone of the herringbone portion so that the parcels exit the conveyor at the side of said inside lateral zones.

12. The singulating conveyor in accordance with claim 9, wherein said transporting rollers and said separate motors and drive systems are supported from a horizontal framework.

13. The singulating conveyor in accordance with claim 9, wherein said drive systems are each sheave and drive band systems.

14. The singulating conveyor in accordance with claim 1, wherein at least three of the transporting rollers in the outside lateral zone closest to the entry end of the conveyor have a higher coefficient of friction than the corresponding rollers of the complementary inside lateral zones.

15. The singulating conveyor in accordance with claim 11, further comprising a parcel guide that extends longitudinally adjacent the outer ends of the transporting rollers of the last inside lateral zone of the herringbone portion and all of the longitudinal zones of the skew portion to help singulate and guide the transported parcels to the exit end of the conveyor.

16. The singulating conveyor in accordance with claim 1, further comprising photoeyes that are installed adjacent the outer ends of the transporting rollers of the outside lateral zones of the herringbone portion to detect the movement of the transported parcels so that the speed of the transporting rollers can be adjusted as necessary.

17. A method for operating a singulating conveyor including transporting rollers extending from an entry end of the conveyor to an exit end of the conveyor and divided into a herringbone portion and a skew portion, each of which has a plurality of longitudinal zones, the transporting rollers of each longitudinal zone in the herringbone portion divided at a longitudinal center line of the conveyor into a pair of complementary outside and inside lateral zones, said transporting rollers of each lateral zone skewed at an angle with an outer end of the rollers being forward compared to an inner end of the rollers so that said longitudinal zones and said lateral zones are arranged in a herringbone pattern, and the longitudinal zones of the skew portion include the discharge rollers which extend to exit end of the conveyor;
said method comprising:
operating said longitudinal zones and said lateral zones at selected speeds to singulate and transport a random flow of parcels from said entrance end of the conveyor to said exit end of the conveyor.

18. The method for operating a singulating conveyor in accordance with claim 17, wherein each of the outside lateral zones is operated at a higher or equal speed to that of its corresponding inside lateral zone.

19. The method for operating a singulating conveyor in accordance with claim 17, wherein at least some of the transporting rollers in the outside lateral zone of a plurality of the longitudinal zones in the herringbone portion operate at a higher coefficient of friction than the complementary inside lateral zones.

20. A singulating conveyor comprising:
transporting rollers extending from an entry end of the conveyor to an exit end of the conveyor and divided into a herringbone portion followed by a skew portion, each of which portions has a plurality of longitudinal zones;
the transporting rollers of each longitudinal zone of the herringbone portion divided into a pair of complementary outside and inside lateral zones, said transporting rollers of each lateral zone skewed at an angle with an outer end of the rollers being forward compared to an inner end of the rollers so that said longitudinal zones and said lateral zones are arranged in a herringbone pattern; and
some of the transporting rollers of at least two of said outside lateral zones having a higher coefficient of friction than its complementary and adjacent inside lateral zone.

21. The singulating conveyor in accordance with claim 20, wherein the speed of the transporting rollers in each of said longitudinal zones and in each lateral zones operate at a selected speed to singulate and transport a random flow of parcels at entry end of the conveyor to the exit end of the conveyor.

22. The singulating conveyor in accordance with claim 20, wherein the transporting rollers of the herringbone portion of the conveyor are divided into six or eight longitudinal zones and two lateral zones, and a separate motor and drive system operates the transporting rollers of each lateral zone in each of the six or eight longitudinal zones, thus a total of twelve or sixteen separate motor and drive systems operating the transporting rollers of the herringbone portion.

23. The singulating conveyor in accordance with claim 20, wherein the skew portion of the conveyor is divided into seven longitudinal zones, and a separate motor and drive system operates the transporting rollers of each longitudinal zones, thus making a total of nineteen or twenty-three separate motor and drive systems operating the transporting rollers of the conveyor.

24. The method for operating a singulating conveyor in accordance with claim 19, wherein the higher coefficient of friction for the transportation rollers in the outside lateral zones is achieved by applying a friction covering to said rollers.

25. The singulating conveyor in accordance with claim 20, wherein said transporting rollers with a higher coefficient of friction have a friction covering.

26. The singularity conveyor in accordance with claim 20, wherein said higher coefficient of friction for some of the transporting rollers of at least two of the outside lateral zones serves to better singulate a random flow of parcels in the herringbone portion of the conveyor than a conveyor having transporting rollers with a lesser coefficient of friction.

27. A method for manufacturing a singulating conveyor having a herringbone portion which includes multiple longitudinal zones of transporting rollers divided at a longitudinal center line of the conveyor into a pair of complementary outside and inside lateral zones, said transporting rollers of each lateral zones skewed at an angle with an outer end of the rollers being forward compared to an inner end of the rollers so that said longitudinal zones and said lateral zones are arranged in a herringbone pattern, and a skew portion of discharge rollers; said method of manufacturing comprising:
forming a first modular conveyor section having at least a first and a second longitudinal zone for an entry end of the conveyor;
forming a second modular conveyor section having at least a last longitudinal zone of the herringbone portion together with the skew portion; and
forming a third modular conveyor section having at least one longitudinal zone of the herringbone portion which can be interconnected at a back end of the first modular conveyor section and at a front end of the second modular conveyor section.

28. The method for manufacturing a singulating conveyor in accordance with claim 27, wherein the herringbone portion includes eight longitudinal zones, the first modular conveyor section includes the first four longitudinal zones of the herringbone portion, the second modular conveyor section includes the last two longitudinal zones of the herringbone portion, and the third modular conveyor section includes the fifth and sixth longitudinal zones of the herringbone portion.

29. The method for manufacturing a singulating conveyor in accordance with claim 28, wherein a separate motor and drive system operates the transporting rollers of each lateral zone in each of the eight longitudinal zones.
